(19) United States
(12) Patent Application Publication
(10) Pub. No.: US 2018/0147776 A1
(43) Pub. Date: May 31, 2018

(54) METHOD FOR PRODUCING PHOTOCURED THREE-DIMENSIONAL STEREOSCOPIC SHAPED OBJECT

(71) Applicant: Kaneka Corporation, Osaka (JP)

(72) Inventor: Jun Kotani, Osaka (JP)

(73) Assignee: Kaneka Corporation, Osaka (JP)

(21) Appl. No.: 15/882,186

(22) Filed: Jan. 29, 2018

Related U.S. Application Data
(63) Continuation of application No. PCT/JP2016/072364, filed on Jul. 29, 2016.

(30) Foreign Application Priority Data
Jul. 29, 2015 (JP) 2015-149905

(51) Int. Cl. B29C 64/112; B29C 64/227; C08F 20/06; C08G 59/17; C08G 71/04; C08G 77/20; C09D 133/10

(52) U.S. Cl. CPC B29C 64/112; B29C 64/227; C08F 20/06; B29L 2011/00; C08G 71/04; C08G 77/20; C09D 133/10; C08G 59/1466

(57) ABSTRACT

A process for producing a photocured three-dimensional stereoscopic shaped object includes ejecting and applying a droplet of a photocurable resin composition (A) having a viscosity of 20 mPa·s to 500 Pa·s at 23° C. using a non-contact dispenser, wherein the droplet has a volume of 1 nL or more.

### TECHNICAL FIELD

One or more embodiments of the present invention relate to a process for producing a photocured three-dimensional stereoscopic shaped object. More specifically, one or more embodiments of the present invention relate to a process for producing a photocured three-dimensional stereoscopic shaped object using a non-contact dispenser.

### BACKGROUND

As one of shaping techniques of stereoscopic objects, a shaping method called a 3D printer has attracted attention in recent years. In this shaping method, three-dimensional shaped slice data of a stereoscopic object to be shaped is created on a computer, a sectional shape based on each slice data is shaped by some method, and the shaped object is laminated, thereby obtaining a desired stereoscopic shaped object. There are several methods for the shaping method, and for example, a stereolithography method, a selective laser sintering method, a fused deposition method, a powder bonding method, a sheet lamination method and an inkjet shaping method are known. Among them, in the case where the obtained shaped object is an organic substance, a stereolithography method using a photocurable resin and an inkjet shaping method are known as a simple method (Patent Document 1).

In the stereolithography method, light (ultraviolet laser light or the like) based on three-dimensional data of a desired molded body is irradiated on the liquid surface of a liquid photocurable resin in a container to cure a predetermined thickness to form a thin layer cured product. By sequentially laminating the layers formed in this way, a molded body having a desired three-dimensional stereoscopic shape is produced (Patent Document 2).

On the other hand, the inkjet shaping method, which is a technique having attracted particular attention in recent years, is a method in which a liquid ultraviolet-curable resin is applied by an inkjet head and cured by a UV lamp to be laminated (Patent Documents 3 and 4). As ejection methods by an inkjet head, there are a bubble jet method in which a heater heats ink in nozzles having a diameter of several microns, bubbles are generated by the heat, and the ink is jetted out by the pressure of the bubbles, and a piezo method in which, by utilizing a piezo element that deforms when electrified, ink is ejected with a mechanical pressure due to the deformation. The photocurable liquid resin composition to be used in either method needs to be smoothly ejected from a fine nozzle, thus the resin composition is required to have a low viscosity (Patent Document 5). In either method, data in which three-dimensional shapes of a desired stereoscopic shaped object are cut on a computer is created, sectional shapes are formed one layer by one layer on the basis of the data, and the obtained sectional shapes are laminated, thereby producing a stereoscopic shaped object.

Patent Documents 6 and 7 describe a method of using a needle dispenser as a liquid material ejecting apparatus that ejects a very small amount of liquid material with a high viscosity, but these documents are silent about an application to a stereoscopic optically shaped object.

Patent Document 8 describes a plastic card in which a liquid material with a high viscosity is applied and a stereoscopic shape is formed on the surface, but the document is silent about an application to a stereoscopic optically shaped object.

Patent Document 9 discloses a method for producing a stereoscopic shaped object by applying a curable liquid resin having a viscosity of 10,000 cps (100 Pa·s) or more, spraying a curing catalyst on the surface with an inkjet dispenser to form a cured film, and repeating this process.

### PRIOR ART DOCUMENTS

### Patent Documents

[Patent Document 1] JP2015-110343A

[Patent Document 2] JP2015-89932A

[Patent Document 3] JP2015-85663A

[Patent Document 4] JP2013-86289A

[Patent Document 5] JP2015-38166A

[Patent Document 6] JP2011-173029A

[Patent Document 7] JP2010-207703A

[Patent Document 8] JP2005-97594A

[Patent Document 9] JP2007-106070A

Advantages and disadvantages each exist in conventionally known processes for producing a photocured three-dimensional stereoscopic shaped object, and a method to be adopted is selected from criteria such as device cost, operation cost, shaping accuracy, shaping speed, and ease of post processing.

In the stereolithography system, there is inferiority in economical efficiency such that a large amount of the liquid photocurable resin that has not been cured in the shaped object needs to be discarded, the resin in the container becomes unnecessary when replacing the material, and the unnecessary resin adhered to the surface of the shaped object needs to be cleaned after shaping.

This has been overcome by the inkjet shaping method, although the shaping time is very long. The shaping time depends on the size (height) of the shaped object and the shaping accuracy (lamination pitch), and it often takes several hours to about half a day.

In particular, since the inkjet dispenser ejects a resin composition having a low viscosity at an extremely small amount, the shaping time is very long while it is excellent in shaping accuracy. Thus, the inkjet dispenser is limited to shaping of prototype, production of customized products such as a prosthetic limb, a denture and an artificial bone, hobby use for individuals, or the like, and it is unsuitable for being used for mass production as an industrial product. Further, in the inkjet dispenser, it is described that the viscosity of the liquid material to be ejected is at most several tens cps (several tens mPa·s) and the eject amount is also at most 60 pL or less. It is also described that 40 times or more lamination is necessary, in order to apply it to a thickness of 400 μm. Therefore, in order to form a stereoscopic shaped object by such a method, a great number of times of lamination is necessary, and thus it is obvious that a great amount of time and energy are spent (Patent Document 8).

Solutions with information processing methods and programs have been attempted as a system for shortening shaping time (Patent Documents 3 and 4), but it is insufficient for shortening shaping time and application of a new device have been desired.

A needle dispenser which ejects a very small amount of the liquid material with a high viscosity described in Patent Documents 6 and 7 needs to transfer the liquid material adhered at the tip of the needle to the object to be adhered, and the adhesion between the cured product and the liquid material is required. With the cured product that does not have sufficient hardness, applying at an accurate position with accurate applying amount is difficult, thus the needle dispenser is not suitable for use as a 3D printer.

According to the method described in Patent Document 8, it is assumed only to form a thickness to the extent that embossing is applied on a plastic card, thus Patent Document 8 describes that one or at most three times of application is sufficient and applying repeatedly to laminate is not necessary.

The dispenser used herein is a contact type air pulse dispenser, in which a polymer material is extruded from an ejection port and applied. In such a dispenser, the ejection port and the ejection liquid of the dispenser, and the ejection liquid and the liquid landing surface are in contact with each other at the same time. Therefore, although ejecting on a flat surface or a slight uneven surface is possible, applying repeatedly with an accurate to large irregular surface like three-dimensional stereoscopic shaped object is impossible, and even when applying is possible, the control of the three-dimensional coater that operates the dispenser becomes complicated, which affects labor and cost.

According to the method of Patent Document 9, the curable liquid resin layer is coated by a recoater device, and only the portion coated with the curing catalyst sprayed by the inkjet dispenser is left as the cured film layer in the final shape. However, finally removing the portion not coated with the curing catalyst by washing or the like is necessary, and in fact, mixing with the curable liquid resin layer is insufficient only by spraying the curing catalyst, so that a vibration device is required to promote mixing and the device is complicated and consumes time to form shaped objects. Thus, the method is not suitable for industrial mass production.

### SUMMARY

As a result of intensive studies on a photocurable resin composition and an apparatus applying the photocurable resin, the present inventor has found that a highly viscous photocurable resin composition may be ejected as droplets of 1 nL (nanoliter) or more using a non-contact dispenser.

One or more embodiments of the present invention relate to a process for producing a photocured three-dimensional stereoscopic shaped object, comprising ejecting and applying a photocurable resin composition (A) having a viscosity at 23° C. of 20 mPa·s to 500 Pa·s as droplets of 1 nL (nanoliter) or more, using a non-contact dispenser.

One or more embodiments of the present invention relate to the process for producing a photocured three-dimensional stereoscopic shaped object, wherein the photocurable resin composition (A) contains a photocurable resin (I) having a photocrosslinkable group represented by a general formula (1):

—OC(O)C(R¹)═CH₂ (1)

wherein R¹ represents a hydrogen atom or an organic group having 1 to 20 carbon atoms.

One or more embodiments of the present invention relate to the process for producing a photocured three-dimensional stereoscopic shaped object, wherein the photocurable resin (I) has an average of at least 0.8 photocrosslinkable groups per molecule at the molecular chain end.

One or more embodiments of the present invention relate to the process for producing a photocured three-dimensional stereoscopic shaped object, wherein the photocurable resin (I) has a molecular weight of 1,000 or more.

One or more embodiments of the present invention relate to the process for producing a photocured three-dimensional stereoscopic shaped object, wherein the photocurable resin (I) is one or two or more kinds selected from the group consisting of urethane (meth)acrylate resins, epoxy (meth)acrylate resins, polyester (meth)acrylate resins, silicone (meth)acrylate resins, and (meth)acrylic (meth)acrylate resins.

One or more embodiments of the present invention relate to the process for producing a photocured three-dimensional stereoscopic shaped object, wherein the photocurable resin (I) is a (meth)acrylic polymer synthesized by a living radical polymerization method.

One or more embodiments of the present invention relate to the process for producing a photocured three-dimensional stereoscopic shaped object, wherein the photocurable resin composition (A) contains 0.01 to 20 parts by weight of a photoinitiator (II) based on 100 parts by weight of the photocurable resin (I).

One or more embodiments of the present invention relate to the process for producing a photocured three-dimensional stereoscopic shaped object, wherein the photocurable resin composition (A) contains 0.1 to 200 parts by weight of a diluent monomer (III) based on 100 parts by weight of the photocurable resin (I).

One or more embodiments of the present invention relate to the process for producing a photocured three-dimensional stereoscopic shaped object, wherein two or more kinds of different photocurable resin compositions (A) are used.

One or more embodiments of the present invention relate to the process for producing a photocured three-dimensional stereoscopic shaped object, light for curing the photocurable resin composition (A) is light having a peak illuminance at a wavelength of 350 nm or more.

One or more embodiments of the present invention relate to the process for producing a photocured three-dimensional stereoscopic shaped object, wherein the non-contact dispenser is a jet dispenser or a pneumatic dispenser.

One or more embodiments of the present invention relate to the process for producing a photocured three-dimensional stereoscopic shaped object, wherein the droplets of the photocurable resin composition (A) ejected from the non-contact dispenser are 1 nL to 1000 nL.

One or more embodiments of the present invention relate to the process for producing a photocured three-dimensional stereoscopic shaped object, wherein, in an apparatus including the non-contact dispenser, a stage for receiving the photocurable resin composition (A) ejected from the dispenser, and a driving unit for moving at least one of the dispenser and the stage, a three-dimensional shape is formed by laminating cured products by repeating ejection and curing of the photocurable resin composition (A) while changing a relative position of the dispenser and the stage by the driving unit.

One or more embodiments of the present invention relate to the process for producing a photocured three-dimensional stereoscopic shaped object, wherein a three-dimensional shape is formed by repeatedly applying the photocurable resin composition (A) five or more times using the non-contact dispenser.

One or more embodiments of the present invention relate to the process for producing a photocured three-dimensional stereoscopic shaped object, wherein at least a part of the photocured three-dimensional stereoscopic object to be obtained has a glass transition temperature (Tg) of 25° C. or less.

One or more embodiments of the present invention relate to a process for producing a shock absorbing material, comprising repeating formation of a coating film of the photocurable resin composition (A) and curing of the coating film to form a desired shape according to any one of the above production process.

One or more embodiments of the present invention relate to a process for producing a vibration-proof material, comprising repeating formation of a coating film of the photocurable resin composition (A) and curing of the coating film to form a desired shape according to any one of the above production process.

One or more embodiments of the present invention relate to a process for producing a damping material, comprising repeating formation of a coating film of the photocurable resin composition (A) and curing of the coating film to form a desired shape according to any one of the above production process.

One or more embodiments of the present invention relate to a process for producing a sealing material, comprising repeating formation of a coating film of the photocurable resin composition (A) and curing of the coating film to form a desired shape according to any one of the above production process.

According to one or more embodiments of the present invention, a photocured three-dimensional stereoscopic shaped object can be easily and quickly produced with high economical efficiency.

### DETAILED DESCRIPTION OF THE EMBODIMENTS

Embodiments for carrying out one or more embodiments of the present invention will be described in detail below.

One or more embodiments of the present invention relate to a process for producing a photocured three-dimensional stereoscopic shaped object, comprising ejecting and applying a photocurable resin composition (A) having a viscosity at 23° C. of 20 mPa·s to 500 Pa·s as droplets of 1 nL (nanoliter) or more, using a non-contact dispenser. More specifically, the photocurable resin composition (A) having a viscosity at 23° C. of 20 mPa·s to 500 Pa·s is ejected as droplets of 1 nL (nanoliter) or more to form a coating film using a non-contact dispenser, and the coating film is cured to form a three-dimensional shape.

According to one or more embodiments of the present invention, the photocurable resin composition (A) is applied to a desired shape using a non-contact dispenser and irradiated with light to form a cured coating film having a desired shape. Thereafter, the photocurable resin composition (A) is further applied thereon and irradiated with light to laminate the cured coating film. By repeating application+photocuring+application+photocuring . . . as described above, a desired three-dimensional stereoscopic shaped object is formed.

First, the photocurable resin composition constituting a photocured three-dimensional stereoscopic shaped object will be described.

### Photocurable Resin Composition (A)

The photocurable resin composition (A) used in one or more embodiments of the present invention is not particularly limited, and a general photocurable resin composition can be used, but in order to ensure the amount that can be ejected at one time without decreasing the ejection speed, the viscosity of the photocurable resin composition (A) at 23° C. is required within the range of 20 mPa·s to 500 Pa·s. In one or more embodiments, the viscosity is more preferably 50 mPa·s to 300 Pa·s, and further preferably 500 mPa·s to 100 Pa·s. The viscosity of the photocurable resin composition (A) can be measured using a rotational viscometer within the range of 0.5 to 100 rpm.

When the viscosity (23° C.) of the liquid photocurable resin composition (A) is less than 20 mPa·s, the droplets to be ejected become small, and as a result, troubles such as inferior shaping speed, increased scattering to the periphery at the time of ejection, and dropping of droplets adhered to the shaped object before photocuring may easily occur.

Also, when the viscosity of the liquid photocurable resin composition (A) is too high, the ejection speed is difficult to increase and consequently the shaping speed becomes slow, and energy for ejecting the photocurable resin composition (A) may be much required. Furthermore, when the viscosity of the curable resin composition (A) is within the above range, the coated body is hardly deformed even on the shaping stage. Therefore, the viscosity of the liquid of the photocurable resin composition (A) at 23° C. may be more appropriate viscosity within the range of 20 mPa·s to 500 Pa·s.

The photocurable resin composition (A) may have the above viscosity also at the ejection port of the dispenser. In order to obtain a more proper viscosity at the ejection port of the dispenser, the ejection port, the nozzle portion, and the liquid reservoir portion may be heated within the range not less than room temperature and not more than 120° C.

The photocurable resin composition (A) used in one or more embodiments of the present invention may contain a photocurable resin (I) and a photoinitiator (II).

### Photocurable Resin (I)

The photocurable resin (I) contained in the photocurable resin composition (A) has a photocrosslinkable group in the molecule, the reaction is initiated by irradiation with light, and a general one is used without particular limitation as long as a cured product is obtained. Examples of such a photocrosslinkable group include an epoxy group, an oxetane group, a vinyl ether group, a hydrolyzable silyl group and the like used for photo cationic or photo anionic polymerization; polymerizable carbon-carbon double bond groups such as (meth)acryloyl group, vinyl group and allyl ether group used for photo radical polymerization; but are not limited thereto. Among them, from the point of high reactivity to light and versatility, the photocrosslinkable group may be a photocrosslinkable group represented by a general formula (1):

—OC(O)C(R¹)═CH₂ (1)

wherein R¹ represents a hydrogen atom or an organic group having 1 to 20 carbon atoms. From the point of availability and rich in photoreactivity, R¹ may be a hydrogen atom or a CH₃ group.

The photocurable resin (I) may have 0.8 to 2.9 photocrosslinkable groups in one molecule on average. When the number of photocrosslinkable groups contained in one molecule is less than 0.8, troubles such as weak strength of the obtained cured product and unavailability of a shaped object having sufficient strength, and gradual deformation after shaping may occur. When the number of photocrosslinkable groups contained in one molecule is more than 2.9, distortion of the obtained cured product tends to be large, and unavailability of a shaped object as designed may occur. In one or more embodiments, the number of photocrosslinkable groups contained in one molecule is more preferably in the range of 0.9 to 2.5 from the point of less distortion of the shaped object and better shape retention, and further more preferably in the range of 1.1 to 1.9 since the mechanical strength of the obtained shaped object is easily increased.

Furthermore, photocurable resin (I) may have at least an average of 0.8 photocrosslinkable groups per molecule at the molecular chain end, since a shaped object with more flexibility, excellent elongation and enhanced mechanical strength is easily obtained.

The photocurable resin (I) used in one or more embodiments of the present invention may be a polymer or oligomer having a photocrosslinkable group at the main chain end and/or side chain. Examples of a general commercial product include polyether (meth)acrylate resins containing a (meth)acrylate group at the molecular chain end or side chain of a polyether polymer, conjugated diene (meth)acrylate resins having a (meth)acryloyl group at the molecular chain end or side chain of a conjugated diene polymer or a hydrogenated product thereof, urethane (meth)acrylate resins having a (meth)acryloyl group at the molecular chain end or side chain of the polyurethane polymer, epoxy (meth)acrylate resins having a (meth)acryloyl group at the molecular chain end or side chain of the epoxy resin, polyester (meth)acrylate resins having a (meth)acryloyl group at the molecular chain end or side chain of the polyester polymer, silicone (meth)acrylate resins having a (meth)acryloyl group at the molecular chain end or side chain of the silicone polymer, (meth)acrylic (meth)acrylate resins having a (meth)acryloyl group at the molecular chain end or side chain of the (meth)acrylic polymer, and (meth)acrylic vinyl resins having a (meth)acryloyl group at the molecular chain end or side chain of the vinyl polymer. In addition, examples of the general commercial product include epoxy resins having an epoxy group or an oxetane group, silicone resins or polyether resins containing reactive silyl group, and polyester resins or polyether resins having a vinyl ether group at the molecular chain end, but the photocurable resin (I) is not limited to these resins.

Among them, one or two or more kinds of photocurable resins selected from urethane (meth)acrylate resins, epoxy (meth)acrylate resins, polyester (meth)acrylate resins, silicone (meth)acrylate resins, and (meth)acrylic (meth)acrylate resins may be used because of the high shaping speed, the ease of adjusting the hardness of the obtained shaped object, and excellent elongation and durability. Further, since the obtained cured product is excellent in flexibility and shock cushioning performance, (meth)acrylic polymers having a photocrosslinkable group at the molecular end may be used. (Meth)acrylic polymers having a (meth)acryloyl group at the molecular chain end may be used because of its rich photoreactivity and easy performance of photocuring reaction.

Examples of a process for producing a (meth)acrylic polymer having a (meth)acryloyl group at the molecular chain end include various processes, but in one or more embodiments, a radical polymerization method is preferable from the point of versatility of monomers, ease of control or the like, and among radical polymerization methods, a controlled radical polymerization method is more preferable. This controlled radical polymerization method can be classified into “chain transfer agent method” and “living radical polymerization method”. In one or more embodiments, a living polymer obtained by living radical polymerization is further preferable from the point that the molecular weight and molecular weight distribution of the obtained (meth)acrylic-based polymer are easily controlled and the obtained cured product is excellent in flexibility and elongation, and atom transfer radical polymerization is particularly preferable due to availability of raw material, and ease of introduction of a functional group into the polymer end. The radical polymerization method, the controlled radical polymerization method, the chain transfer agent method, the living radical polymerization method, and the atom transfer radical polymerization method are known polymerization methods, and for each of these polymerization methods, for example, the description of JP 2005-232419 A and JP 2006-291073 A and the like can be referred to. As one example, Kaneka XMAP manufactured by Kaneka Corporation is well known.

In order to maintain the shaping speed, the photocurable resin composition (A) is required to have a viscosity of 20 mPa·s or more, thus the molecular weight of the photocurable resin (I) may be 1,000 or more. The molecular weight of the photocurable resin (I) may be 1,000 to 100,000 from the point of the ease and quickness of adjusting the ejection amount of the photocurable resin composition, and the molecular weight may be 3,000 to 50,000, from the point of excellent mechanical strength of the shaped object.

When the molecular weight of the photocurable resin (I) is less than 1,000, the viscosity of the obtained photocurable resin composition is too low, troubles such as leakage from the ejection device, dripping on the shaped object, and distortion in the shaped object due to the relatively high concentration of the photocrosslinkable group may occur.

The molecular weight of the photocurable resin (I) is represented by the number-average molecular weight (Mn) measured by gel permeation chromatography (GPC). In the GPC measurement of one or more embodiments of the present invention, chloroform is mainly used as a mobile phase, measurement is performed with a polystyrene gel column, and the number-average molecular weight and the like can be obtained in terms of polystyrene.

In one or more embodiments, the molecular weight distribution (weight-average molecular weight [Mw]/number-average molecular weight [Mn]) of the photocurable resin (I) is preferably less than 1.8, more preferably 1.7 or less, further preferably 1.6 or less, still more preferably 1.5 or less, particularly preferably 1.4 or less, and most preferably 1.3 or less. When the molecular weight distribution is too large, not only the viscosity of the curable resin composition becomes high and handling becomes difficult but also control of the thermosensitivity tends to be difficult, which causes stringing and liquid reservoir at the time of ejection. Furthermore, it tends to be difficult to control the mechanical properties of the obtained stereoscopic shaped object.

The photocurable resin (I) may be used alone, or in a mixture of a plurality of resins. When a plurality of resins are mixed and used, the number of photocrosslinkable groups of each resin may be 0.9 to 2.9 on average. The average number of photocrosslinkable groups when a plurality of resins are mixed is calculated in the same manner as the AFB value (“average functionality of blend”) defined in paragraph [0028] of JP 2014-531489 A. That is, in the case of using X kinds of resins as the photocurable resin (I), the average number of photocrosslinkable groups is calculated as (the number of photocrosslinkable groups of resin 1)×(wt % of resin 1 in the mixture)+(the number of photocrosslinkable groups of resin 2)×(wt % of resin 2)+ . . . +(the number of photocrosslinkable groups of resin X)×(wt % of resin X).

### Photoinitiator (II)

The photocurable resin composition (A) used in one or more embodiments of the present invention preferably contains a photoinitiator (II). The photoinitiator (II) is not particularly limited, but in one or more embodiments, a photo-radical initiator is preferably used from the point of high reactivity to light. Examples of the photo-radical initiator include acetophenone, propiophenone, benzophenone, xanthol, fluorene, benzaldehyde, anthraquinone, triphenylamine, carbazole, 3-methylacetophenone, 4-methylacetophenone, 3-pentylacetophenone, 2,2-diethoxyacetophenone, 4-methoxyacetophenone, 3-bromoacetophenone, 4-allylacetophenone, p-diacetylbenzene, 3-methoxybenzophenone, 4-methylbenzophenone, 4-chlorobenzophenone, 4,4′-dimethoxybenzophenone, 4-chloro-4′-benzylbenzophenone, 3-chloroxanthone, 3,9-dichloroxanthone, 3-chloro-8-nonylxanthone, benzoin, benzoin methyl ether, benzoin butyl ether, bis(4-dimethylaminophenyl)ketone, benzyl methoxy ketal, 2-chlorothioxanthone, 2,2-dimethoxy-1,2-diphenylethan-1-one (trade name: IRGACURE 651, manufactured by BASF Japan), 1-hydroxy-cyclohexyl-phenyl-ketone (trade name: IRGACURE 184, manufactured by BASF Japan), 2-hydroxy-2-methyl-1-phenyl-propan-1-one (trade name: DAROCUR1173, manufactured by BASF Japan), 1-[4-(2-hydroxyethoxy)-phenyl]-2-hydroxy-2-methyl-1-propan-1-one (trade name: IRGACURE 2959, manufactured by BASF Japan), 2-methyl-1-[4-(methylthio)phenyl]-2-morpholinopropan-1-one (trade name: IRGACURE 907, manufactured by BASF Japan), 2-benzyl-2-dimethylamino-1-(4-morpholinophenyl)-butanone-1 (trade name: IRGACURE 369, manufactured by BASF Japan), 2-(4-methylbenzyl)-2-dimethylamino-1-(4-morpholin-4-yl-phenyl)-butan-1-one (trade name: IRGACURE 379, manufactured by BASF Japan), dibenzoyl, bis(η⁵-2,4-cyclopentadien-1-yl)-bis(2,6-difluoro-3-(1H-pyrrol-1-yl)-phenyl)titanium (trade name: IRGACURE 784, manufactured by BASF Japan Ltd.), and the like.

Among them, α-hydroxyketone compounds (for example, benzoin, benzoin methyl ether, benzoin butyl ether, 1-hydroxy-cyclohexyl-phenyl-ketone, and the like.) and phenyl ketone derivatives (for example, acetophenone, propiophenone, benzophenone, 3-methylacetophenone, 4-methylacetophenone, 3-pentylacetophenone, 2,2-diethoxyacetophenone, 4-methoxyacetophenone, 3-bromoacetophenone, 4-allylacetophenone, 3-methoxybenzophenone, 4-methylbenzophenone, 4-chlorobenzophenone, 4,4′-dimethoxybenzophenone, 4-chloro-4′-benzylbenzophenone, bis(4-dimethylaminophenyl) ketone, and the like) may be used.

Furthermore, an initiator species capable of suppressing polymerization defect due to oxygen inhibition on the surface of the cured product can also be used as the photoinitiator (II), and examples of such initiator species include photo-radical initiators having two or more photodegradable groups in the molecule, and hydrogen abstraction type photo-radical initiators having three or more aromatic rings in the molecule.

Examples of the photo-radical initiators having two or more photodegradable groups in the molecule include 2-hydroxy-1-[4-[4-(2-hydroxy-2-methyl-propionyl)-benzyl]phenyl]-2-methyl-propan-1-one (trade name: IRGACURE 127, manufactured by BASF Japan), 1-[4-(4-benzoxylphenylsulfanyl)phenyl]-2-methyl-2-(4-methylphenylsulfonyl)propan-1-one (trade name: ESURE1001M), methyl benzoyl formate (trade name: SPEEDCURE MBF, manufactured by LAMBSON LTD.) O-ethoxyimino-1-phenylpropan-1-one (trade name: SPEEDCURE PDO, manufactured by LAMBSON LTD.), and oligo [2-hydroxy-2-methyl-[4-(1-methylvinyl)phenyl]propanone (trade name: ESCURE KIP150, manufactured by LAMBERTI S.p.A.). Examples of the hydrogen abstraction type photo-radical initiators having three or more aromatic rings in the molecule include 1,2-octanedione,1-[4-(phenylthio)-,2-(O-benzoyloxime)] (trade name: IRGACURE OXE-01, manufactured by BASF Japan), ethanone,1-[9-ethyl-6-(2-methylbenzoyl)-9H-carbazol-3-yl]-1-(0-acetyloxime) (trade name: IRGACURE OXE-02, manufactured by BASF Japan), trade name: IRGACURE OXE-03 (unknown structural formula, manufactured by BASF Japan), IRGACURE OXE-04 (unknown structural formula, manufactured by BASF Japan), 4-benzoyl-4′-methyldiphenylsulfide, 4-phenylbenzophenone, 4,4′,4″-(hexamethyltriamino)triphenylmethane, and the like. In addition, acylphosphine oxide based photo-radical initiators such as 2,4,6-trimethylbenzoyl-diphenyl-phosphine oxide (trade name: IRGACURE TPO, manufactured by BASF Japan), bis(2,4,6-trimethylbenzoyl)-phenylphosphine oxide (trade name: IRGACURE 819, manufactured by BASF Japan) and bis(2,6-dimethylbenzoyl)-2,4,4-trimethyl-pentylphosphine oxide, characterized by improved deep-part curability, may also be used as the photoinitiator (II).

In one or more embodiments, from the point of the balance between curability and storage stability of the photocurable resin composition (A), as the photoinitiator (II), more preferred are benzophenone, 4-methylbenzophenone, 1-hydroxy-cyclohexyl-phenyl-ketone (trade name: IRGACURE 184, manufactured by BASF Japan), 2-hydroxy-2-methyl-1-phenyl-propan-1-one (trade name: DAROCUR 1173, manufactured by BASF Japan), bis(4-dimethylaminophenyl) ketone, 2-hydroxy-1-[4-[4-(2-hydroxy-2-methyl-propionyl)-benzyl]phenyl]-2-methyl-propan-1-one (trade name: IRGACURE 127, manufactured by BASF Japan), 2-benzyl-2-dimethylamino-1-(4-morpholinophenyl)-butanone-1 (trade name: IRGACURE 369, manufactured by BASF Japan), 2-(4-methylbenzyl)-2-dimethylamino-1-(4-morpholin-4-yl-phenyl)-butan-1-one (trade name IRGACURE 379, manufactured by BASF Japan), 2,4,6-trimethylbenzoyl-diphenyl-phosphine oxide (trade name: IRGACURE TPO, manufactured by BASF Japan), bis(2,4,6-trimethylbenzoyl)-phenylphosphine oxide (trade name: IRGACURE 819, manufactured by BASF Japan), bis(2,6-dimethylbenzoyl)-2,4,4-trimethyl-pentylphosphine oxide, and 1,2-octanedione,1-[4-(phenylthio)-,2-(O-benzoyloxime)] (trade name: IRGACURE OXE-1, manufactured by BASF Japan).

These photoinitiators (II) may be used alone, in a mixture of two or more, or in combination with other compounds.

Specific examples of the combination of the photoinitiator (II) and other compound include a combination of the photoinitiator (II) and an amine such as 4,4′-bis(dimethylamino)benzophenone, 4,4′-bis (diethylamino)benzophenone, diethanolmethylamine, dimethylethanolamine, triethanolamine, ethyl-4-dimethylaminobenzoate or 2-ethylhexyl-4-dimethylaminobenzoate; a combination of the photoinitiator (II) and a phosphorus compound such as triethylphosphine, tri-n-propylphosphine, triisopropylphosphine, tri-n-butylphosphine, tributylphosphine, triphenylphosphine, tris(2,6-dimethoxyphenyl)phosphine, triphenylphosphine oxide, triphenyl phosphate, triphenyl phosphite or diphenyl(p-vinylphenyl)phosphine; those further combined with an iodonium salt such as diphenyliodonium chloride; and a combination of a dye such as methylene blue and an amine with the photoinitiator (II).

When the photo-radical initiator is used as the photoinitiator (II), polymerization inhibitors such as hydroquinone, hydroquinone monomethyl ether, benzoquinone and p-tert-butyl catechol can also be added, if necessary.

The amount of the photoinitiator (II) to be added is not particularly limited, but in one or more embodiments, from the point of curability and storage stability, it is preferably 0.01 to 20 parts by weight, based on 100 parts by weight of the photocurable resin (I), and further preferably 0.5 to 6 parts by weight from the point of better surface curability of the shaped object.

In one or more embodiments, when the photocrosslinkable group of the photocurable resin (I) is an epoxy group, an oxetane group, a vinyl ether group or a hydrolyzable silyl group, it is preferable to use a photo cation generator or a photo anion generator. As the photo cation generator, any compound capable of generating a cation or an acid by absorbing light having an appropriate wavelength in irradiation light at the time of curing the photocurable resin composition (A) can be appropriately used. Examples thereof include organic sulfonium salt type, iodonium salt type, and phosphonium salt type. Examples of the counter ion of these compounds include antimonate, phosphate, borate, and the like.

As the photo anion generator, the compound capable of generating an anion by absorbing light of an appropriate wavelength in irradiated light can be suitably used, as with the photo cation generator. In one or more embodiments, the photo anion generator is more preferable than the photo cation generator because there is no concern of corrosion by acid. Examples of the photo anion generator include carbamates, acyloximes, and ammonium salts. Specific examples of commercially available products include the WPBG series manufactured by Wako Pure Chemical Industries, Ltd, and the like.

When the photo cation generator or photo anion generator is used, a basic substance or an acid substance can also be used to improve the photocuring rate.

The amount of the photo cation generator or photo anion generator to be added is not particularly limited, but in one or more embodiments, it is preferably 0.01 to 10 parts by weight, based on 100 parts by weight of the photocurable resin (I) from the point of curability and storage stability, and more preferably 0.5 to 5 parts by weight from the point of better curability of the shaped object.

### Diluent Monomer (III)

In the photocurable resin composition (A) as described herein, it is possible to use a diluent monomer (III) having a photopolymerizable group in combination, for the purpose of improving the ejection property by adjusting the viscosity and improving the physical properties of the shaped object.

Specific examples of the diluent monomer (III) include various reactive diluents described in paragraphs [0103] to [0113] of JP 2015-71719 A, and among them, isononyl acrylate, isodecyl acrylate, lauryl acrylate, isostearyl acrylate, 2-decyltetradecanyl acrylate, isobornyl (meth)acrylate, dicyclopentenyl acrylate, dicyclopentanyl acrylate, dicyclopentenyloxyethyl acrylate, acryloyl morpholine, γ-(acryloyloxypropyl)trimethoxysilane, methoxypolyethylene glycol acrylate, trimethylolpropane triacrylate, trimethylolpropane polyethoxytriacrylate, tricyclodecane dimethylol diacrylate, and 1,9-nonanediol diacrylate may be used, from the point that they are excellent in improvement in the mechanical strength of the shaped object, excellent in work environmental compatibility due to less odor, and suitable for adjusting the viscosity of the photocurable resin composition. These diluent monomers (III) may be used alone or two or more kinds thereof may be used.

In one or more embodiments, the amount of the diluent monomer (III) to be added is not particularly limited, and is preferably 0.1 to 200 parts by weight, based on 100 parts by weight of the photocurable resin (I) from the point of excellent low viscosity effect and good curability, and more preferably 5 to 50 parts by weight from the point of excellent mechanical strength of the shaped object.

### Filler

A filler can be added to the photocurable resin composition (A) within a range not inhibiting photocuring. Specific examples thereof include various fillers and fine hollow particles described in paragraphs [0134] to [0151] of JP 2006-291073 A. Among them, from the point of imparting light weight and toughening the shaped object, beads such as polyacrylic resin, polyacrylonitrile-vinylidene chloride resin, phenol resin and polystyrene resin and hollow fine particles thereof; inorganic hollow fine particles such as glass balloon; fumed silica and wet process silica may be used. These fillers may be used alone or two or more kinds thereof may be used.

### Plasticizer

A plasticizer can be added to the photocurable resin composition (A). By adding a plasticizer, viscosity of the photocurable resin composition (A) and mechanical characteristics such as tensile strength and elongation of the obtained shaped object can be adjusted, and transparency of the shaped object can be improved.

The plasticizer is not particularly limited, and may be appropriately determined depending on the purpose such as adjustment of physical properties and adjustment of appearance. Specific examples of the plasticizer include phthalic acid esters such as dibutyl phthalate, diheptyl phthalate, di(2-ethylhexyl) phthalate and butyl benzyl phthalate; nonaromatic dibasic esters such as dioctyl adipate, dioctyl sebacate, dibutyl sebacate and isodecyl succinate; aliphatic esters such as butyl oleate and methyl acetylricinoleate; esters of polyalkylene glycols such as diethylene glycol dibenzoate, triethylene glycol dibenzoate and pentaerythritol ester; phosphates such as tricresyl phosphate and tributyl phosphate; trimellitic acid esters; pyromellitic acid esters; polystyrenes such as polystyrene and poly-α-methylstyrene; diene copolymers such as polybutadiene, polybutene, polyisobutylene, butadiene-acrylonitrile and polychloroprene; chlorinated paraffins; hydrocarbon oils such as alkyl diphenyl and partially hydrogenated terphenyls; process oils; polyethers such as polyether polyols such as polyethylene glycol, polypropylene glycol and polytetramethylene glycol and derivatives obtained by converting a hydroxyl group of these polyether polyols into an ester group, ether group or the like; epoxy plasticizers such as epoxidized soybean oil and benzyl epoxy stearate; polyester-based plasticizers obtained from a dibasic acid such as sebacic acid, adipic acid, azelaic acid or phthalic acid and a dihydric alcohol such as ethylene glycol, diethylene glycol, triethylene glycol, propylene glycol or dipropylene glycol; vinyl polymers obtained by polymerizing a vinyl monomer including an acrylic plasticizer like ARUFON series manufactured by TOAGOSEI CO., LTD., by various methods; and the like. These plasticizers may be used alone or two or more kinds thereof may be used.

### Solvent

A solvent can be added to the photocurable resin composition (A), if necessary.

Examples of the solvent that can be blended include aromatic hydrocarbon solvents such as toluene and xylene; ester solvents such as ethyl acetate, butyl acetate, amyl acetate and cellosolve acetate; ketone solvents such as acetone, methyl ethyl ketone, methyl isobutyl ketone and diisobutyl ketone; alcoholic solvents such as methanol, ethanol and isopropanol; and hydrocarbon solvents such as hexane, cyclohexane, methylcyclohexane, heptane and octane. These solvents may be used alone or two or more kinds thereof may be used.

### Thixotropic Additive (Antisag Agent)

A thixotropic additive (antisag agent) may be added to the photocurable resin composition (A), in order to adjust the viscosity of the liquid, if necessary.

The thixotropic additive is not particularly limited, and examples thereof include hydrogenated castor oil derivatives, metal soaps having a long chain alkyl group, ester compounds having a long chain alkyl group, inorganic fillers such as silica, amide wax, and the like. These thixotropic additives may be used alone or two or more kinds thereof may be used.

### Antioxidant

For the photocurable resin composition (A), an antioxidant (antiaging agent) can be used, if necessary. By using the antioxidant, heat resistance of the shaped object can be enhanced. Examples of the antioxidant include primary antioxidants such as general hindered phenolic antioxidants, an amine-based antioxidants, lactone-based antioxidants and aminoethanol-based antioxidants, and secondary antioxidant such as sulfur-based oxidizing agents and phosphorus-based oxidizing agents. As the antioxidant, those described in paragraphs [0232] to [0235] of JP 2007-308692 A and paragraphs [0089] to [0093] of WO 2005/116134 A can be used. These antioxidants may be used alone or two or more kinds thereof may be used.

### Other Additives

Various additives may be added to the photocurable resin composition (A), if necessary, for the purpose of adjusting various physical properties of the photocurable resin composition or the shaped object to be obtained. Examples of such additives include compatibilizers, surface modifiers, curability modifiers, radical inhibitors, metal deactivators, ozone deterioration inhibitors, phosphorus peroxide decomposers, lubricants, pigments, antifoaming agents, foaming agents, termite preventing agents, fungicides, ultraviolet absorbers, light stabilizers, tackifier resins, adhesion imparting agents, coloring agents, and the like. Specific examples other than specific examples of the additives referred herein are described in, for example, JP H04-69659 B, JP H07-108928 B, JP S63-254149 A, JP S64-22904 A, JP 2001-72854 A, and the like.

In the process for producing a three-dimensional stereoscopic shaped object as described herein, two or more different types of photocurable resin compositions (A) may be used, from the viewpoint of imparting functionality to the obtained stereoscopic shaped object. In such a case, a non-contact coater (non-contact dispenser) also needs to be used corresponding to each liquid. By using two or more different photocurable resin compositions (A), it becomes possible to obtain a shaped object having different physical properties and characteristics for each parts in one stereoscopic shaped object. Such a shaped object is conventionally produced by separately processing and shaping each part, then produced by assembling, bonding together the parts, or the like. In such a method, much labor and time are required. However, by using two or more kinds of the photocurable resin compositions (A) in the process of one or more embodiments of the present invention, it becomes possible to produce a shaped object having different physical properties and characteristics for each part in a single operation, and also, according to one or more embodiments of the present invention, it becomes possible to produce a shaped object which cannot be obtained by the conventional process, for example, it becomes possible to prepare a shaped object in which parts having different physical properties are completely embedded.

### Non-Contact Dispenser

The non-contact dispenser used in one or more embodiments of the present invention may be any coater as long as it is a coater capable of jetting droplets with high precision from a position distant from the liquid landing point (impact point of the droplet), and among which, either a jet dispenser or a pneumatic dispenser is suitably used.

Dispensers capable of applying a resin composition having a high viscosity of 20 mPa·s to 500 Pa·s are conventionally well known, and examples thereof include ordinary air pulse dispenser and screw dispenser, a gear pump dispenser, a MOHNO dispenser, a mechanical dispenser, and a pressurized dispenser, and the like.

However, since these general dispensers are for linearly or planarily applying liquid, there are limitations on shapes that can be drawn by linear/planar ejection, thus it is impossible to form complicated shapes like a three-dimensional stereoscopic shaped object.

In order to form a three-dimensional stereoscopic shaped object, it is necessary to eject droplets in dots like an already known inkjet dispenser, but the upper limit of the viscosity of the liquid which can be ejected with the inkjet dispenser is 20 mPa·s, and the limit of the volume of droplets to be ejected is also 100 pL (picoliters). As described above, in the inkjet dispenser, the droplet to be ejected is very fine, thus the film thickness formed by one ejection is very thin, and it is necessary to repeat great number of times of lamination in order to obtain a shaped object. Thus it is known that the inkjet dispenser may take time and cost.

This may be overcome by using a needle dispenser which can apply a high viscosity liquid in dots (Patent Documents 6 and 7), but as described above, it is unsuitable for use as a 3D printer.

On the other hand, the non-contact dispenser used in one or more embodiments of the present invention is a coater capable of jetting droplets with high precision from a position distant from the landing point, and there is no moment when the liquid landing surface and the ejection port are in contact at the same time, the moment is present in the above-described ordinary dispenser. In the non-contact dispenser, the droplets are landed on the liquid landing surface after leaving the ejection port. Therefore, the up-and-down motions of the dispenser itself is not needed, so it is possible to apply and laminate the photocurable resin composition precisely and stably even for those with large irregularities, such as three-dimensional stereoscopic shaped object. In addition, applying time is shortened since unnecessary up-and-down motions are omitted.

As such a non-contact dispenser, for example, either a jet dispenser or a pneumatic dispenser is suitably used.

The jet dispenser is a device which continuously ejects a liquid material in a droplet form at a high speed, and rapidly moves forward a plunger in a liquid chamber having the ejection port toward an ejection port and then suddenly stops the plunger, thereby ejecting the liquid material from the ejection port in the form of droplets. Examples of a driving system of these plunger parts include the mechanical type utilizing a reciprocating motion of a plunger or a rod part by air pressure, spring force, displacement of a piezo element, or a piezo jet type. Utilizing the reciprocating motion of the plunger portion makes it possible to eject high volume droplets that cannot be obtained by the inkjet dispenser. This mechanism is totally different from the ejection mechanism of the bubble jet system utilizing bubble of bubble generation caused by rapid heating of the heating unit, which is one of the inkjet dispensers, or the piezo system utilizing the driving force of the piezo element for ejecting droplets as it is.

The pneumatic dispenser ejects liquid materials in the form of droplets by a method of releasing the solenoid valve for a short time while increasing and maintaining the pressure in the holding container which holds a liquid with a gas having a pressure from a compressor or a cylinder.

The inner diameter of the ejection port provided in the non-contact dispenser can be appropriately determined according to the viscosity of the photocurable resin composition (A) and the amount of droplets ejected at one time.

Examples of such non-contact dispenser include AeroJet, CyberJet and CyberJet2 manufactured by Musashi engineering, NEO-JET manufactured by Iwashita Engineering, Inc., Hi accurate Jet Dispenser manufactured by SAN-EI TECH Ltd., Dispense Jet Series (PICO P μ Ise) manufactured by Nordson Corporation, a piezo jet dispenser (Stream Jet valve) manufactured by SSI JAPAN, and the like, but the non-contact dispenser is not limited thereto.

Droplets of the photocurable resin composition (A) ejected at one time from the non-contact dispenser are 1 nL (nanoliter) or more. In one or more embodiments, the droplets are preferably 1 nL or more, more preferably 2 nL or more, further preferably 5 nL or more, preferably 1000 nL or less, more preferably 200 nL or less, and further preferably 140 nL or less. When the droplets are smaller than 1 nL, the film thickness to be laminated is not sufficient, thus it is necessary to increase the number of times of lamination, and time and energy are required. On the other hand, when the droplets exceed 1000 nL, the number of times of lamination can be reduced, but the precision of the detail of the shaped object is inferior.

The non-contact dispenser may be installed in a robot that can be three-dimensionally driven. In one or more embodiments, the photocurable resin composition (A) is three-dimensionally applied by the non-contact dispenser installed in the robot which can be three-dimensionally driven. The robot that can be three-dimensionally driven is, for example, a robot having movable parts in three axial directions, the X direction, the Y direction and the Z direction, and it becomes possible to eject droplets to an arbitrary position in the planar direction by driving in the X direction and the Y direction in which an ordinary coating robot can use, and as the shaped object increases in thickness in the Z-axis direction (direction perpendicular to the plane) with the number of times of lamination repeatedly, the driving in the Z direction becomes possible, if necessary. Therefore, according to the apparatus (robot) of one or more embodiments equipped with a non-contact dispenser, a stage (shaping stage) for receiving the photocurable resin composition (A) ejected from the dispenser, and a driving unit for moving at least one of the dispenser and the stage, on the basis of slice data of a three-dimensional shape of a stereoscopic shape to be shaped, the slice data being prepared in advance, a three-dimensional shape can be formed by laminating cured products by repeating ejection and curing of the photocurable resin composition (A) while changing the relative position of the dispenser and the stage by the driving unit. The non-contact dispenser, the stage and the robot may be installed in the casing.

In order to obtain a three-dimensional stereoscopic shaped object, the shaped object is required to have a sufficient thickness. For that reason, the number of times of application using a non-contact dispenser may be 5 or more. More specifically, a step of forming a coating film of the photocurable resin composition (A) by using a non-contact dispenser and curing the coating film (the number of times of application) may be 5 or more. When it is not more than 4 times, a cured product in the form of a thin film can be obtained, but it is difficult to obtain a stereoscopic object that can be called as a three-dimensional stereoscopic shaped object, in some cases. The upper limit of the number of times of application depends on the size of the stereoscopic shaped object desired to be produced, thus cannot be determined uniformly, but it goes without saying the number of times of application may be small since the time can be made shorter.

In the production method as described herein, after applying the photocurable resin composition (A) using a non-contact dispenser, light is irradiated to form a cured film. Light may be irradiated for each application (one layer of slice data), but light may be irradiated after applying the photocurable resin composition (A) a plurality of times, instead of each application. For such light irradiation, a light source can be used as long as it is a light source used for ordinary photocuring reaction, and examples thereof include solar rays, low pressure mercury lamps (sterilizing lamps, fluorescent chemical lamps, black lights), fluorescent lamps, incandescent lamps, medium pressure mercury lamps, high pressure mercury lamps, super-high pressure mercury lamps, carbon arc lamps, metal halide lamps, gallium lamps, tungsten lamps, xenon lamps, mercury xenon lamps, chemical lamps, electrodeless discharge lamps, zirconium lamps, UV-LED, and the like. Among them, high-pressure mercury lamps, metal halide lamps, electrodeless discharge lamps, and UV-LED are suitable as a light source, from the point of easy handling and economic al efficiency. Further, light having a peak illuminance at a wavelength of 350 nm or more (light having a peak wavelength at 350 nm or more) may be used for its safety to workers and low energy.

Generally, it is known that the photocurable resin is liable to cause surface curing inhibition by oxygen inhibition, and in order to avoid this, the oxygen concentration in the irradiation atmosphere may be reduced using an inert gas such as nitrogen gas or carbon dioxide gas. In such a case, in order to improve the reaction rate of the photocurable resin, the oxygen concentration in the irradiation atmosphere may be 5000 ppm or less, or 500 ppm or less.

As a shaping apparatus that can be used in the production process as described herein, one having a stage for shaping a stereoscopic shaped object, a non-contact dispenser for ejecting a photocurable resin (A) onto the shaping stage to form a coated body of the photocurable resin (A) on the shaping stage, and a light source for irradiating light to the coated body of the photocurable resin composition (A) formed on the shaping stage may be used. The shaping apparatus may have two or more non-contact dispensers, and two or more non-contact dispensers may be installed in a robot that can be three-dimensionally driven. Besides these, the shaping apparatus can have a configuration similar to that of the stereolithography apparatus used in an inkjet stereolithography method. Further, in one or more embodiments of the present invention, the production process can also be applied to a production line for continuously producing a three-dimensional stereoscopic shaped object.

### About Physical Properties of Stereoscopic Shaped Object

Since the three-dimensional stereoscopic shaped object produced by the process of one or more embodiments of the present invention is a laminate of a cured coating film of the photocurable resin composition (A) to be used, the physical properties of the three-dimensional stereoscopic shaped object depend largely on the physical properties of the cured product of the photocurable resin composition (A). When the viscosity of the photocurable resin composition (A) is within the range of 20 mPa·s to 500 Pa·s, the physical properties of the cured product are varied, and three-dimensional stereoscopic shaped objects with various physical properties such as flexible rubbery elastic property and a resin-like property of high hardness used for coating, can be obtained. Further, using two or more kinds of the photocurable resin compositions (A)enables to obtain those which were difficult to produce by the conventional method, such as composites of two or more rubbery cured products, and composites of a resinous cured product and a rubbery cured product. Among them, a rubbery cured product having a glass transition temperature (Tg) of 25° C. or lower may be used as a part of the obtained three-dimensional stereoscopic shaped object. When the glass transition temperature (Tg) of a part of the three-dimensional stereoscopic shaped object is 25° C. or less, the three-dimensional stereoscopic shaped object is excellent in shock absorption and flexibility.

### Applications

From the point of high degree of freedom in design and excellent production speed, the above three-dimensional stereoscopic shaped object can be used for various applications other than prototypes used in conventional 3D printers and the like, customized products for medical and nursing care, and hobby use.

The above three-dimensional stereoscopic shaped object is useful for sports applications, toys/play equipment applications, stationery applications, medical and nursing care applications, footwear applications, bedclothes/bedding applications, home furnishing applications, clothing applications, various miscellaneous goods applications, transportation applications, OA equipment, household electric appliances, audio equipment, portable equipment, industrial machinery and equipment, precision equipment, electric and electronic equipment, electric and electronic parts, various industrial applications, building materials applications and the like, as a sealing material, a coating material, an adhesive, a pressure-sensitive adhesive, a molded body, a sealant, a molded part, a foam, a resist material, an on-site forming gasket, a shock absorbing material, a shock cushioning material, a pressure dispersion material, a damping material, a vibration-proof material, a sound absorbing material, a sound-proof material, a heat insulating material, and a touch feeling improving member. Among them, a sealing material, a shock absorbing material, a vibration-proof material, a damping material and the like are useful as an application in which excellent shock absorbing properties and flexibility of the obtained shaped object are utilized.

When used for various applications, the three-dimensional stereoscopic shaped object can also be used as a shock absorber, an insulator, a bush, various mounts, a film, a sheet, a tape, a seal, a chip, or a molded member.

For sports applications, the three-dimensional stereoscopic shaped object is useful for molded body applications, sealing material applications, sealant applications, shock absorbing applications, shock cushioning applications, pressure dispersion applications, damping applications, vibration-proof applications, sound absorbing applications, sound insulation applications, touch feeling improving applications at the contact part with the human body and the like, such as a shock cushioning material placed in fences at ball game ground, stadium and the like; landing mats for gymnastics and exercise; a floor exercise mat; a gym stretching mat; a kids mat; a bouldering mat (crash pad); a beat board; a cushioning material for high jumping; a wet suit; grips and core materials of golf club, bat, tennis racket or the like; core materials of grab and mitt; an overlay, sockliner, an insole and a shoe sole of sports shoe; liners of ski boots and snowboard boots; toe shoes; ballet shoes; a golf club head; protectors for sports (for example, headgears used in rugby or fighting sports such as boxing, helmets for baseball and football, elbow pads for baseball, soccer and fighting sports, leg guards (shin guards), and the like); a racket; a ball; a motorcycle clothing; gloves (for football's keeper gloves, golf, ski and rider); a rifle jacket (for example, shoulder pads); and the like.

For toys/play equipment applications, the three-dimensional stereoscopic shaped object is useful for molded body applications, sealing material applications, sealant applications, shock absorbing applications, shock cushioning applications, pressure dispersion applications, damping applications, vibration-proof applications, sound absorbing applications, sound insulation applications, touch feeling improving applications at the contact part with the human body and the like, such as cushioning materials and packing such as seal, hand exerciser, healing goods, a key holder, a stuffed toy, a moving stuffed toy, a mannequin body, a ball and a massage ball; articles for decorating such as game controller and mat, mobile phone, smartphone or the like; materials for preparing other ornaments; an animal model; a monster and a doll; figures; and the like.

For medical and nursing care applications, the three-dimensional stereoscopic shaped object can be used as artificial skin, artificial bone, artificial cartilage, artificial organ, artificial cornea, artificial lens, artificial vitreous, artificial muscle, artificial blood vessel, artificial joint, a human phantom, breast pad and a material for insertion for swimwear and breast enlargement, or other biocompatible material, and some can be also used for a liquid medicine exuding pad; a hemostatic pad; a gas-liquid separation filter (indwelling needle filter); a patch; a medical liquid absorbing tool; a mask; a compression pad; a surgical disposable product; tube, cap, bag, gasket and hose for medical use; bed, treatment table and chair for medical use; an electrocardiography electrode material; an electrode pad for low frequency therapy equipment; a sensor pad; a mattress for preventing bed sore; a cushion for postural change; a cushion for wheelchair; a seating face of wheelchair; nursing care products such as a shower chair; a bath support pillow; a taping; a liner for plaster cast; a material for soft contact lens; artificial limb and leg themselves and a cushioning material for connecting artificial leg or limb to human body (such as liners), or a material for constituting a joint part of artificial leg or limb; a denture pad and other dental products; a shock absorbing pad; a hip protector; a protector for elbow and knee; a body shape auxiliary material after a surgery; a poultice material; a wound dressing; a cell culture sheet; a biological model for treatment practice; or the like. In addition, as an article to be used in contact with the human body, the three-dimensional stereoscopic shaped object is useful for, for example, a cushioning material for pain of corn or callus, a supporter, a slippage preventing material for pumps or the like, or a drying prevention pad for elbow or heel, shock absorbing applications for foot care for relieving pain due to hallux jump, ingrown nail or the like. Besides, the three-dimensional stereoscopic shaped object can be also used for a pressure-sensitive adhesive for a transdermal drug or patch, a pharmaceutical or medical sealing material, a medical pressure-sensitive adhesive, a medical rubber stopper, an impression material, a dental filling material, a syringe gasket, a decompressed blood vessel rubber stopper, an O-ring or a flat gasket for artificial dialysis equipment, drug and medical equipment packaging materials, a cap, a cap liner, a vacuum blood collection tube cap, a catheter sealing material or adhesive, a sealing material or adhesive for an implanted medical device or attached-type sensors, and the like.

For footwear applications, the three-dimensional stereoscopic shaped object can be used for men's shoes, ladies' shoes, children's shoes, shoes for the elderly, sports shoes, safety shoes, and the like, and is useful for shock absorbing applications, comfort improvement applications and beauty and slimming applications, such as a skin material of each shoe, a lining, an insole (inner sole), shoe soles (outsole, midsole, heel), a shoe sore prevention pad, various shoe pads, inner boots, slippers, a slipper core, sandals, a sandal insole, and the like.

Examples of bedclothes/bedding applications include bedsore prevention applications, body pressure dispersion applications, sleeping comfort improvement applications, shock absorbing applications and the like, such as a pillow, a comforter, a Japanese mattress, a bed, a bed for hairdressing/beauty, a mattress, a bed mat, a bed pad, a cushion, a baby bed and a neck pillow for baby, and the like.

Examples of home furnishing applications include body pressure dispersion applications and sitting comfort improvement applications, shock absorbing applications, touch feeling improving applications and the like, such as a chair, a legless chair, a floor cushion, a sofa, various cushions such as sofa cushion, seat cushion and loin guard cushion, carpets and mats, kotatsu carpet and comforter, a toilet seat mat, and the like. Examples include touch feeling improving applications, shock absorbing applications, sound insulation applications, molded body applications and the like of, a handle or grip, a handrail or a doorstop of desk, closet, clothes case, bookshelf, stairs, door, opening, fusuma, shoji or sliding door, or the like.

Examples of clothing applications include shock absorbing applications and heat insulating applications, molded body applications and the like, such as pad materials for shoulders, brassieres or the like, a cold protection material, a helmet, a bulletproof vest, or the like.

For various miscellaneous goods applications, the three-dimensional stereoscopic shaped object can be used as molded body applications, sealing material applications, shock absorbing applications, cushioning applications, damping applications, vibration-proof applications, sound absorbing applications, sound attenuation applications, touch feeling improving applications at the contact part with the human body and the like, such as bath products such as bath pillow, a puff for massage, a mouse pad, an arm rest and a wrist rest for personal computer, an anti-slip cushion, stationery (pen grip, self-inking stamp material), a small pillow for use on the desk, an earplug, a cotton swab, a sheet for hot pack, a sheet for cold pack, a poultice, an eyeglass pad, a pad for swimming goggle, a face protector, a pad for wrist watch, an ear pad for headphone, an earphone, a heat keeping cup, a beverage can, an ice pillow cover, a folding pillow, writing instruments, bags (for example, shoulder hanging part, holding part of satchel, and the like), grips for daily miscellaneous goods/carpenter's goods, members for rugs such as a member for carpet and a member for artificial turf, an elbow pad, a knee pad, a glove, a simulated bait for fishing, and a material for preventing saddle sore for horseback by saddle, or the like.

Examples of transportation applications include molded body applications, sealing material applications, damping applications, vibration-proof applications, shock absorbing applications, sound absorbing applications, sound insulation applications, cushioning applications, touch feeling improving applications at the contact part with the human body and the like, such as interior materials of a seat, a child seat, a headrest, an armrest, a footrest, a headliner, a saddle, a rider cushion, a helmet, a custom car mattress, a camper cushion, a ceiling material, a door trim, a floor cushion instrument panel, a dashboard, a door panel, an inner panel, a shift knob, a handle, a grip, a pillar, a console box, an air bag cover, a parking brake cover, a quarter trim, a lining, a center pillar garnish, a sun visor and the like for automobile, motorcycle, bicycle, electric bicycle, tricycle, stroller, construction machinery, railway vehicle, ship, aircraft or the like; in-vehicle electronic apparatuses such as recording reproducing apparatus and various sensors of in-vehicle navigation system and control equipment; parts around the engine such as a harness, a dust cover, a hose, an engine, a battery, an oil pan, a front cover and a locker cover; parts around the vehicle body such as a tire, a bumper, a floor, an underfloor, a door, a roof, a panel, a wheel house, a transmission, a weather strip, various accessory covers, a window packing, a roof molding, a lower door molding, a seat back, a trunk room and a cargo bed, or the like. In addition, examples include vibration-proof applications, damping applications, shock absorbing applications and vibration absorbing applications of tools for carrying persons and loads such as a carry bag, a carriage, a container, a flexible container, or a pallet. Examples of the items to be carried include work of art, precision equipment, fruits, vegetables, fresh fish, eggs, ceramics/porcelain, and medical products such as regenerated cells, and they can be used for direct packaging, indirect packaging or conveying the packaged one. Also, the three-dimensional stereoscopic shaped object can also be used as a shock absorber, an insulator, a bush, various mounts, a film sheet, a tape, a seal, a chip or a molded member, for transportation, carriage and conveyance. The three-dimensional stereoscopic shaped object can be used for an automobile vibration-proof rubber, a railway vehicle vibration-proof rubber, an aircraft vibration-proof rubber, a fender or the like, as a vibration-proof rubber.

Furthermore, in the field of automobiles, as a body part, the three-dimensional stereoscopic shaped object can be used for a sealing material for maintaining airtightness, a vibration prevention material for glass, a car body section vibration-proof material, and especially as a window seal gasket or a door glass gasket. As a chassis part, the three-dimensional stereoscopic shaped object can be used as an engine or suspension rubber for vibration proofing and sound proofing, and especially as an engine-mounted rubber. As an engine part, the three-dimensional stereoscopic shaped object can be used for hoses for cooling, fuel supply, exhaust control and the like; a gasket for an engine cover or an oil pan; an engine oil sealing material, or the like. The three-dimensional stereoscopic shaped object can also be used for an exhaust gas cleaning equipment part or a brake part. Further, as a tire part, the three-dimensional stereoscopic shaped object can be used as a sealing material in a bead portion, a sidewall portion, a shoulder portion or a tread portion, and also for an inner liner resin, an air-pressure sensor or puncture sensor. In addition, the three-dimensional stereoscopic shaped object can be used as a sealing material, a sealant, a gasket, a coating material, a molding member, an adhesive or a pressure-sensitive adhesive, for various electronic components and control components. Moreover, the three-dimensional stereoscopic shaped object can be used as a covering material for a wire harness made from copper or aluminum, or as a sealing material for a connector part. Additionally, the three-dimensional stereoscopic shaped object can also be used as a sealing material, an adhesive, a pressure-sensitive adhesive, a molded part such as a gasket, an O-ring, packing or a belt or the like of a lamp, a battery, a windshield washer fluid unit, an air conditioning unit, a coolant unit, a brake oil unit, an electrical part, various interior and exterior parts, an oil filter or the like, as well as a potting material for an igniter HIC or an automotive hybrid IC.

For various equipment applications, the three-dimensional stereoscopic shaped object is useful for molded body applications, sealing material applications, sealant applications, vibration-proof applications, damping applications, shock absorbing applications, shock cushioning applications, sound absorbing applications, sound insulation applications, touch feeling improving applications at the contact part with the human body, and as an adhesive, a pressure-sensitive adhesive, packing, a gasket, an O-ring, or a belt of OA equipment (display, personal computer, telephone, copier, printer, copying machine, game machine, TV, various recorders such as Blu-ray recorder and HDD recorder, various players such as DVD player and Blu-ray player, projector, digital camera, home video, antenna, speaker, electronic dictionary, IC recorder, fax, telephone, stepping motor, magnetic disk, hard disk, and the like).

The three-dimensional stereoscopic shaped object is useful for vibration-proof applications, damping applications, shock absorbing applications, shock cushioning applications, sound absorbing applications, sound insulation applications and touch feeling improving applications at the contact part with the human body such as handles and grips, openings, doors and handrails, and as a sealing material, an adhesive, a pressure-sensitive adhesive, packing, an O-ring, and a belt of household electric appliances (refrigerator, washing machine, washing dryer, futon dryer, vacuum cleaner, air cleaner, water purifier, electric toothbrush, lighting equipment, air conditioner, air conditioner outdoor machine, dehumidifier, humidifier, fan heater, fan, ventilation fan, dryer, massager, blower, sewing machine, dishwasher, dish dryer, intercom, rice cooker, microwave, oven range, IH cooking heater, hot plate, various chargers, iron, and the like).

The three-dimensional stereoscopic shaped object is useful for vibration-proof applications, damping applications, shock absorbing applications, and shock cushioning applications of audio equipment (speaker, turntable, optical pickup device, optical recording/reproducing device, magnetic pickup device, magnetic recording/reproducing device, insulator, spacer, and the like).

The three-dimensional stereoscopic shaped object is useful for vibration-proof applications, damping applications, shock cushioning applications, and touch feeling improving applications at the contact part with the human body of portable equipment such as a notebook computer, a portable hard disk, a mobile phone, a smartphone, a portable music information device, or a portable game machine.

In electrical and electronic applications, for example, the three-dimensional stereoscopic shaped object can be used for an LED material, various battery peripheral materials, sensors, a semiconductor peripheral material, a circuit board peripheral material, a display peripheral material such as liquid crystal, an illumination material, an optical communication/optical circuit peripheral material, an optical recording peripheral material, a magnetic recording material, and the like.

For an LED material, the three-dimensional stereoscopic shaped object can be used as a molding material, a sealant, a sealing film, a die-bonding material, a coating material, a sealing material, an adhesive, a pressure-sensitive adhesive, a lens material or the like, for an LED element, as well as a sealing material, an adhesive, a pressure-sensitive adhesive, a coating material or the like for an LED bulb, an LED indicator, an LED display board, an LED display device, and the like.

For a battery peripheral material, the three-dimensional stereoscopic shaped object can be used as a sealing material, a rear face sealant, a molding material for each element, an adhesive, a pressure-sensitive adhesive, a sealant, a sealing film, a coating material, a potting material, a filler, a separator, a catalyst fixing film, a protective film, an electrode binding agent, a sealing material for refrigerant oil, a hose material or the like for a lithium-ion battery, a sodium-sulfur battery, a sodium molten-salt battery, an organic radical battery, a nickel hydrogen battery, a nickel cadmium battery, a redox flow battery, a lithium sulfur battery, an air battery, an electrolytic capacitor, an electric double layer capacitor, a lithium ion capacitor, a fuel cell, a solar cell, a dye-sensitized solar cell, and the like.

For sensors, the three-dimensional stereoscopic shaped object can be used as a sealant, a sealing film, a vibration absorbing material, a vibration suppressing material, a lens material, an adhesive, a pressure-sensitive adhesive, a coating agent, a film or the like, for various kinds of sensors for power, load, impact, pressure, rotation, vibration, contact, flow rate, solar radiation, light, smell, time, temperature, humidity, wind speed, distance, position, inertia, slope, velocity, acceleration, angular velocity, hardness, strain, sound, magnetism, current, voltage, power, electron, radiation, infrared ray, X-ray, UV-ray, fluid volume, weight, gas volume, ion content, metal content, color, and the like.

For a circuit board peripheral material, the three-dimensional stereoscopic shaped object can be used as a sealing material, a coating material, a conformal coating material, a potting material, a molding material for each of the below-described element, an underfill material, a die-bonding material, a die bonding film, an adhesive, a pressure-sensitive adhesive, a sealant or a sealing film, for a rigid or a flexible wiring board or MEMS (micro-electro-mechanical system) on which various elements of an IC, an LSI, a semiconductor chip, a transistor, a diode, a thyristor, a capacitor, a resistor, a coil or the like are mounted.

For a display peripheral material, the three-dimensional stereoscopic shaped object can be used as a molding material; various filters; films such as a protective film, an antireflection film, a viewing angle compensation film, a polarizer protective film and an optical compensation film; a sealing material; an adhesive; a pressure-sensitive adhesive; a sealant; a sealing film; a coating material of a substrate or a member; a potting material; a filler; a visibility improver; a lens material; a light guide plate; a prism sheet; a polarizing plate; a retardation plate or a liquid crystal dam material; for each element of a liquid crystal display, a plasma display, a LED display device, an organic EL (electroluminescence) display, a field emission display, electronic paper, a flexible display, a 3D hologram, an organic thin film transistor display, a head-mounted display, and the like.

For an illumination material, the three-dimensional stereoscopic shaped object can be used as a sealing material, a coating material, an adhesive agent, a sealant or a molded part, of an LED for illumination, an organic EL for illumination, and an inorganic EL for illumination.

For an optical communication/optical circuit peripheral material, the three-dimensional stereoscopic shaped object can be used as a molding material, a sealing material, an adhesive, a pressure-sensitive adhesive, a sealant, a sealing film, a coating material, a potting material, a filler, a protective film, a lens material, a light guide plate, a prism sheet, a polarizing plate or a ferrule, for each element of an organic photorefractive element, an optical fiber, an optical switch, a lens, an optical waveguide, a light emitting element, a photodiode, an optical amplifier, an optoelectronic integrated circuit, an optical connector, an optical coupler, an optical processing element, a photoelectric converter, a laser element, and the like.

For an optical recording material, the three-dimensional stereoscopic shaped object can be used as a protective film, a sealing material, an adhesive, a pressure-sensitive adhesive, a sealant, a sealing film, a coating material, an vibration-proof material or a damping material, for a VD (video disc), a CD, a CD-ROM, a CD-R, a CD-RW, a DVD, a DVD-ROM, a DVD-R, a DVD-RW, a BD, a BD-ROM, a BD-R, a BD-RE, an MO, an MD, a PD (phase change disc), a hologram, a disc substrate material for an optical card, a pickup lens, and the like.

For a magnetic recording material, the three-dimensional stereoscopic shaped object can be used as a vibration-proof material, a damping material, a sealing material, an adhesive, a pressure-sensitive adhesive, a sealant, a coating material, a cover gasket or a card material, for a hard disk, a magnetic tape, and a magnetic card such as a credit card.

For information electrical devices, the three-dimensional stereoscopic shaped object can be used as a sealing material, a sealant, an adhesive, a pressure-sensitive adhesive, packing, an O-ring, a belt, a vibration-proof material, a damping material, a sound-proof material or the like, for a mobile phone, a media player, a tablet terminal, a smartphone, a portable game machine, a computer, a printer, a scanner, a projector, an inkjet tank, and the like.

In addition, the three-dimensional stereoscopic shaped object can also be used for a touch panel dirt-resistant film, a lubricating film, an IC chip molding material, a Peltier element molding material, an electrolytic capacitor sealing body, a cable joint potting material, a potting material for an IGBT (a vehicle propulsion control device), a semiconductor wafer processing dicing tape, a die-bonding agent, a die-bonding film, an underfill, an anisotropic conductive adhesive, an anisotropic conductive film, a conductive adhesive, a conductive paste, a thermally conductive adhesive, a thermally conductive paste, a temporary fixing film, a fixing film, a sealing film, or the like.

As other industrial machinery, electric and electronic equipment and parts thereof, the three-dimensional stereoscopic shaped object is useful for vibration-proof applications, damping applications, shock absorbing applications, shock cushioning applications, and touch feeling improving applications at the contact part with the human body, such as a micro-electro-mechanical component called MEMS and various sensors, a control device and a battery, a battery peripheral member, an LED material, a semiconductor peripheral material, a circuit board peripheral material, a display peripheral material such as liquid crystal, an illumination material, an optical communication/optical circuit peripheral material, an optical recording peripheral material, a magnetic recording material, an electron microscope and other science and engineering equipment, various measuring devices, a vending machine, a TV camera, a resistor, a cabinet, a robotic skin shooter, an elevator, an escalator, a moving sidewalk, a conveyor, a lift, a tractor, a bulldozer, a power generator, a compressor, a container, a hopper, a conveyor for fruit sorting machine, an automatic cash machine (ATM), an exchange machine, a counting machine, a vending machine, a cash dispenser (CD), a secondary battery such as a lithium battery, semiconductor manufacturing apparatuses such as an IC tray and a conveyor, a vibration damping steel plate, machines with violent motor vibration such as rock drilling machines, cutting machines, chain saws, hand mixers, mowers, and the like.

In the field of home electronics, the three-dimensional stereoscopic shaped object can be used for a packing, an O-ring, a belt, and the like. Specific examples thereof include decorations of lighting equipment, waterproof packings, vibration-proof rubbers, mothproof packings, a vibration-proof and soundproof air sealing material for a cleaner, a drip-proof cover for an electrical calorifier, a waterproof packing, a packing for a heater region, a packing for an electrode region, a safety valve diaphragm, hoses for a sake warmer, a waterproof packing, an electromagnetic valve, waterproof packings for a steam microwave oven and a rice cooker, a water supplying tank packing, a water absorbing valve, a water-receiving packing, a connecting hose, a belt, a packing for temperature-keeping heater region, an oil packing for a burning appliance such as a seal for a vapor spout, an O-ring, a drain packing, a pressing tube, a blast tube, an air-sending/absorbing packing, a vibration-proof rubber, an oil supply port packing, an oil gauge packing, an oil transfer tube, a diaphragm valve, an air sending tube and the like, a speaker gasket, a speaker edge, a turntable seat, a belt and a pulley for an acoustic appliance, and the like.

For building materials applications, the three-dimensional stereoscopic shaped object is useful for vibration-proof applications, damping applications, shock cushioning applications, shock absorbing applications, damping applications for soundproofing of low-frequency sounds and high-frequency sounds near the audible threshold region, such as a soundproof panel, a soundproof glass, a general glass, a ceiling material, an interior wall material, an exterior wall material, a floor material, a piping material, a water supply member, a building material such as fences, an air film structural roofing material, a structural gasket (zipper gasket), a seismic isolation rubber, a vibration-proof rubber, a sheet, a waterproof sheet, an irregular gasket, a regular gasket, a waterproof material, a sealing material, a packing, a grommet, a packaging transport material, a damping sheet for residence, a vibration damper material, a damping material for bridges, a sound-proof material, a setting block, a sliding material, a glass sealing material for laminated glass and double-glazed glass, an anti-rust and waterproof sealant on the end face (cut part) of wire glass and laminated glass, a shutter, a curtain rail, a curtain wall, a seismic isolator, a ground improvement material or the like.

In the marine and civil engineering field, the three-dimensional stereoscopic shaped object can be used for a rubber expansion joint, a shoe, a water stop, a waterproof sheet, a rubber dam, an elastic pavement, a vibration proof pad, a protective barrier or the like as a structural material; for a rubber mold form, a rubber packer, a rubber skirt, a sponge mat, a mortar hose, a mortar strainer or the like as a construction auxiliary material; for rubber sheets, an air hose or the like as a construction aid material; for a rubber buoy, a wave absorbing material or the like as a safety precaution product; for an oil fence, a silt fence, an antifouling material, a marine hose, a dredging hose, an oil skimmer or the like as an environmental protection product; or the like. The three-dimensional stereoscopic shaped object can also be used for a rubber plate, a mat, a foam plate, or the like.

For applications particularly required for damping material, vibration-proof material, soundproof material and seismic isolation material, the three-dimensional stereoscopic shaped object can also be used for electrical and electronic device applications such as damping materials for a stepping motor, a magnetic disk, a hard disk, a vending machine, a speaker frame, a BS antenna and a VTR cover; architectural applications such as damping materials for a roof, flooring, a shutter, a curtain rail, a floor, a plumbing duct, a deck plate, a curtain wall, stairs, a door, a seismic isolator and a structural material; architectural applications such as a viscoelastic damper and an antiseismic mat; nautical applications such as damping materials for an engine room and a measurement room; automotive applications such as damping materials for an engine (oil pan, front cover, locker cover), a car body (dashboard, flooring, door, roof, panel, wheel house), a transmission, a parking brake cover and a seat back; camera and office equipment applications such as damping materials for a TV camera, a copying machine, a computer, a printer, a cash register and a cabinet; industrial machinery-related applications such as damping materials for a shooter, an elevator, an escalator, a conveyor, a tractor, a bulldozer, a power generator, a compressor, a container, a hopper, a soundproof box and a mower motor cover; railway applications such as damping materials for a railway carriage roof, a side plate, a door, an underfloor, various auxiliary covers and a bridge; damping materials for precision anti-vibration equipment for semiconductor applications; and damping materials for soundproofing of low-frequency sounds and high-frequency sounds near the audible threshold region.

Besides, the cured product of one or more embodiments of the present invention can be used as packing, an O-ring, a belt, a tube, a hose, a valve, a sheet or the like, as a molded body.

The three-dimensional stereoscopic shaped object can also be used as various kinds of adhesives, such as a reactive hot melt agent for a wiring connector, a reactive hot melt adhesive, an OCA (optically transparent adhesive), an elastic adhesive, a contact adhesive, an anaerobic adhesive, a tile adhesive, a UV-ray curable adhesive, an electron beam curable adhesive, and an adhesive for touch panel or touch sensor.

The three-dimensional stereoscopic shaped object can also be used for modification of butyl-based pressure-sensitive adhesive, or as various kinds of pressure-sensitive adhesives such as masking tape, pipe anticorrosion tape, architectural waterproofing tape, self-fusing electrical tape, a removable pressure-sensitive adhesive, and a fusing tape for electrical wire.

The three-dimensional stereoscopic shaped object can also be used for various coating applications, such as a covering material of wiring, cable or optical fiber or a repair material thereof; an insulation sealing material for a wire connection portion; a lining material for a pipe such as a gas pipe or a water pipe; a coating material for an inorganic filler and an organic filler; and a release material for a molding in an epoxy mold.

The three-dimensional stereoscopic shaped object can also be used as various sheets, such as a heat conduction sheet, a heat dissipation sheet, an electromagnetic wave absorption sheet, a conductive sheet, a waterproof sheet, an automotive protective sheet, and a panel shock absorbing sheet.

The three-dimensional stereoscopic shaped object can be used as a shock absorbing gel; a shock absorbing material in beds, shoes and the like; an intermediate layer film for laminated glass; a paint such as an elastic paint or an aqueous emulsion; a prepreg; various rollers for OA equipment or conveyance; a cap liner; an ink repellent; ink; sealing materials for various refrigerant; a sealing material and gasket for industrial and food cans; a foam gasket; a paint; a powder paint; a foam, a sealing material for a can lid or the like; a film; a gasket; a marine deck caulking; a casting material; various molded materials; and an artificial marble.

The three-dimensional stereoscopic shaped object can also be used for resist applications such as dry film resist applications and electrodeposition resist applications. However, the application of the three-dimensional stereoscopic shaped object according to one or more embodiments of the present invention is not obviously limited to the applications exemplified above.

Among the applications exemplified above, for example, a vibration-proof material, a vibration damping material or a sealing material of various materials, equipment and the like can be produced by repeating application of the photocurable resin composition (A) and curing of the coating film to form into a desired shape. Further, the three-dimensional stereoscopic structure obtained by the above production method may be formed into a desired shape by further processing such as cutting, polishing, punching, and the like.

The three-dimensional stereoscopic shaped object according to one or more embodiments of the present invention may be used singly or in combination with other members, if necessary. Using a desired mold, the photocurable resin composition (A) may be laminated and cured in the mold, and the resultant may be used with the mold.

Further, a composite molded body may be obtained by laminating, fitting or sandwiching the obtained three-dimensional stereoscopic shaped object with film, rubber, plastic, metal, wood, cloth, ceramics, glass or the like.

This application claims benefit of priority based on Japanese Patent Application No. 2015-149905 filed on Jul. 29, 2015. The entire content of the specification of Japanese Patent Application No. 2015-149905 filed on Jul. 29, 2015 is incorporated herein by reference.

### EXAMPLES

Specific examples of one or more embodiments of the present invention will be described below, but the present invention is not limited to the following examples. The following examples, “parts” and “%” represent “parts by weight” and “% by weight”, respectively.

The “number-average molecular weight (Mn)” and “molecular weight distribution (ratio of weight-average molecular weight (Mw) to number-average molecular weight (Mn))” were calculated by standard polystyrene conversion method using gel permeation chromatography (GPC). However, one packed with a polystyrene crosslinked gel as a GPC column (shodex GPC K-804, K-802.5; manufactured by SHOWA DENKO K.K.) and chloroform as a GPC solvent were used.

Also, the number of functional groups introduced per molecule of the polymer was calculated based on the concentration analysis by ¹H-NMR and the number-average molecular weight determined by GPC. Herein, NMR measurement was performed at 23° C. using ASX-400 manufactured by Bruker Corporation, and deuterated chloroform was used as a solvent.

### Synthesis Example 1

### Synthetic Example of Poly(n-Butyl Acrylate) Polymer [P1] Having Acryloyl Group

According to a known method, using cuprous bromide as a catalyst, pentamethyldiethylenetriamine as a ligand, diethyl-2,5-dibromoadipate as an initiator, n-butyl acrylate as a monomer, polymerization was performed by setting the ratio (n-butyl acrylate)/(diethyl-2,5-dibromoadipate) to 160 (weight ratio, the same applies hereinafter) to obtain n-butyl polyacrylate terminated with bromine groups.

This polymer was dissolved in N,N-dimethylacetamide, potassium acrylate was added thereto, and the mixture was heated and stirred at 70° C. in a nitrogen atmosphere. After distilling off the N,N-dimethylacetamide in the mixture solution under reduced pressure, butyl acetate was added to the residue, and insoluble matter was removed by filtration. The butyl acetate in the filtrate was distilled off under reduced pressure to obtain a poly(n-butyl acrylate) polymer [P1] having acryloyl groups at both ends.

The number-average molecular weight of the polymer [P1] was 23,000, the molecular weight distribution was 1.1, and the average number of acryloyl groups introduced per molecule of the polymer was about 1.9 as determined by ¹H-NMR analysis.

### Synthesis Example 2

### Synthetic Example of Poly(n-Butyl Acrylate) Polymer [P2] Having Acryloyl Group

The same procedure was carried out as in Synthesis Example 1, except that ethyl α-bromobutyrate was used as an initiator and the monomer/initiator ratio was set to 80, to obtain poly(n-butyl acrylate) polymer [P2] having an acryloyl group at one end.

The number-average molecular weight of the polymer [P2] was 12,000, the molecular weight distribution was 1.1, and the average number of acryloyl groups introduced per molecule of the polymer was about 0.9 as determined by ¹H-NMR analysis.

### Synthesis Example 3

### Synthetic Example of Poly(n-Butyl Acrylate)/(Ethyl Acrylate)/(Methoxyethyl Acrylate) Copolymer [P3] Having Acryloyl Group

The same procedure was carried out as in Synthesis Example 1, except that n-butyl acrylate/ethyl acrylate/methoxyethyl acrylate at 73 parts/25 parts/2 parts was used as the monomer, the monomer/initiator ratio was set to 240, to obtain poly(n-butyl acrylate)/(ethyl acrylate)/(methoxyethyl acrylate) copolymer [P3] having an acryloyl groups at both ends.

The number-average molecular weight of the copolymer [P3] was about 35,000, the molecular weight distribution was 1.3, and the average number of acryloyl groups introduced per molecule of the polymer was about 2.0 as determined by ¹H-NMR analysis.

### Physical Property Evaluation Method

The physical properties of the photocurable resin composition and its cured product were evaluated according to the following methods and conditions.

### Viscosity

In accordance with JIS K 7117-2: 1999 cone-flat plate system, the photocurable resin composition was adjusted to a predetermined measurement temperature (23° C. and/or 60° C.) using an E type viscometer manufactured by Toki Sangyo Co., Ltd, and then measured at the same temperature.

### Tensile Properties

In accordance with JIS K 6251: 2010, a 2 mm thick stereoscopic shaped object produced in the following experimental example was punched out in accordance with dumbbell No. 3 type, and this was used for the measurement. Tensile stress at fracture (denoted as tensile strength) and elongation at fracture (denoted as elongation) were determined at a tensile rate of 500 mm/min.

### Compression Permanent Set

Using a large specimen for measurement of compression permanent set test in accordance with JIS K 6262: 2013, a permanent compression set test was carried out under predetermined conditions.

### Hardness

In accordance with JIS K 6253: 2012, three specimens each having a thickness of 2 mm were stacked and measured using a type A durometer. Also, three specimens each having a thickness of 2 mm were stacked and measured using a type E durometer.

### Dynamic Viscoelasticity

Using a specimen (thickness: 2 mm, width: 5 mm, length: 10 mm) prepared from the stereoscopic structure obtained in the following example, the measurement was performed at a shear mode with a dynamic viscoelasticity measurement device DVA-200 manufactured by IT Keisoku Seigyo, Co. Ltd., at a frequency of 5 Hz and a strain of 0.05%, and the temperature showing a peak of a loss tangent (tan δ) was defined as a glass transition temperature (Tg).

### Formulation Example 1

To 100 parts of the polymer [P1] obtained in Synthesis Example 1 were added 2 parts of Nocrac (registered trademark, the same applies hereinafter) CD (manufactured by

OUCHI SHINKO CHEMICAL INDUSTRIAL CO., LTD.) as an antioxidant, 36 parts of ISTA (manufactured by OSAKA ORGANIC CHEMICAL INDUSTRY LTD., isostearyl acrylate) and 2 parts of Viscoat#295 (manufactured by OSAKA ORGANIC CHEMICAL INDUSTRY LTD., trimethylolpropane triacrylate) as diluent monomers, 5 parts of IRGACURE 379 (manufactured by BASF Japan Ltd., 2-(4-methylbenzyl)-2-dimethylamino-1-(4-morpholin-4-yl-phenyl)-butan-1-one) as a photo-radical initiator, and 1 part of 4,4′-bis(diethylamino)benzophenone (manufactured by Tokyo Chemical Industry Co., Ltd.) as an additive, and the mixture was sufficiently dissolved and mixed, then defoamed to obtain a photocurable resin composition [A1].

The viscosity of the obtained photocurable resin composition [A1] was 11.1 Pa·s (23° C.) and 1.1 Pas (60° C.).

The coating film of the photocurable resin [A1] was irradiated with ultraviolet light having a peak illuminance of 400 mW/cm² and an accumulated light amount of 5000 mJ/cm² using LH-6 (bulb: H-bulb) manufactured by Fusion Systems Japan Co., Ltd. as a ultraviolet irradiation device to prepare a rubbery molded body having a thickness of 2 mm. A specimen was prepared from this rubbery molded body, and its dynamic viscoelasticity was measured to obtain a glass transition temperature (Tg), which was found to be −25° C.

### Example 1

Using the photocurable resin composition [A1] obtained in Formulation Example 1, with a non-contact jet dispenser AeroJet manufactured by Musashi engineering as a non-contact dispenser, one droplet was applied at a nozzle port temperature of 60° C., using a desk-top robot SHOTMASTER DS manufactured by Musashi engineering as a coating robot. After ejection, the applied droplet was cured with 365 nm UV-LED light using EXECURE-H-1VC manufactured by HOYA Corporation as an ultraviolet irradiation device.

The ejected droplet was applied with a diameter of about 0.78 mm and a thickness of about 100 μm. The applied volume was 40 nL to 60 nL.

Similarly, the photocurable resin composition [A1] was continuously ejected in droplet form while moving the robot, to be applied in a rectangular shape of 14 mm×79 mm. The time required for applying was 40 seconds. After applying, the applied droplets were cured with 365 nm UV-LED light using EXECURE-H-1VC manufactured by HOYA Corporation as an ultraviolet irradiation device. A smooth coating film having a thickness of about 100 μm was formed.

The same process was repeated 5 times to obtain a stereoscopic shaped object of 14 mm×79 mm×thickness of 0.5 mm. The time taken at this time was 250 seconds.

### Formulation Example 2

To 30 parts of the polymer [P1] obtained in Synthesis Example 1 and 70 parts of the polymer [P2] obtained in Synthesis Example 2 were added 1 part of IRGANOX 1010 (manufactured by BASF Japan) as an antioxidant, 20 parts of LA (manufactured by KYOEISHA CHEMICAL Co., LTD, lauryl acrylate) and 1 part of Viscoat#295 (manufactured by OSAKA ORGANIC CHEMICAL INDUSTRY LTD., trimethylolpropane triacrylate) as diluent monomers, and 2.5 parts of IRGACURE OXE-01 (manufactured by BASF Japan, 1,2-octanedione,1-[4-(phenylthio)-,2-(O-benzoyloxime)]) as a photo-radical initiator, and the mixture was sufficiently dissolved and mixed, then defoamed to obtain a photocurable resin composition [A2]. The viscosity of the obtained photocurable resin composition [A2] was 5.0 Pa·s (23° C.).

### Example 2

The photocurable resin composition [A2] obtained in Formulation Example 2 was used, and the apparatus obtained by installing a UV-LED irradiator manufactured by CCS Inc. (HLDL-100U6, irradiation surface of 7 cm square, wavelength of 365 nm) as an ultraviolet irradiation device in the same apparatus as in Example 1 was used, so that applying and irradiation with a UV-LED light source can be continuously performed. One droplet was ejected at a nozzle port temperature of 60° C., and the applying amount was found to be 60 nL to 80 nL.

The photocurable resin composition [A2] was continuously ejected in droplet form while moving the robot, to be applied to an area of 25 mm×70 mm, and this coating film was irradiated with ultraviolet light at about 200 mW/cm² for 5 seconds using the above UV-LED irradiator (wavelength of 365 nm) to obtain a smooth coating cured film having a thickness of about 200 μm.

The same process was repeated ten times to obtain a stereoscopic shaped object of 25 mm×70 mm×thickness of 2 mm. The time taken at this time was 14 minutes.

A specimen having a predetermined shape was cut out from the obtained stereoscopic shaped object, and the tensile properties were measured. As a result, the tensile strength was 0.08 MPa, and the elongation was 170%. The hardness was 0 or less for type A durometer and 12 for type E durometer.

Similarly, the photocurable resin composition [A2] was ejected in a circular shape to obtain a disk-shaped coating cured film, this process was repeated 62 times to laminate the cured films, to obtain a sample for compression permanent set test with a diameter of 29 mm and a thickness of 12.5 mm. The time taken at this time was 27 minutes. A compression set test at 25% compression and at 150° C. for 72 hours was carried out using this sample, and the compression set was found to be 22%.

### Formulation Example 3

To 100 parts of the polymer [P3] obtained in Synthesis Example 3 was added 1 part of IRGANOX 1010 (manufactured by BASF Japan) as an antioxidant, 50 parts of ACMO (manufactured by KJ Chemicals Corporation, acryloyl morpholine), 10 parts of LIGHT ACRYLATE 130A (manufactured by KYOEISHA CHEMICAL Co., LTD, methoxy-polyethylenegrycol acrylate) and 1 part of Viscoat#295 (manufactured by OSAKA ORGANIC CHEMICAL INDUSTRY LTD., trimethylolpropane triacrylate) as diluent monomers, 2.5 parts of IRGACURE OXE-01 (manufactured by BASF Japan, 1,2-octanedione,1-[4-(phenylthio)-,2-(O-benzoyloxime)]) as a photo-radical initiator, and 0.01 parts of RDW-R13 manufactured by Wako Pure Chemical Industries, Ltd. as a coloring agent, and the mixture was sufficiently dissolved and mixed, then defoamed to obtain a photocurable resin composition [A3]. The viscosity of the obtained photocurable resin composition [A3] was 7.8 Pa·s (23° C.).

### Example 3

Using the photocurable resin composition [A3] obtained in Formulation Example 3, one droplet was ejected at a nozzle port temperature of 60° C. using the same apparatus as in Example 2. The ejected droplet (1 drop) had an applying amount of 80 nL to 100 nL.

The photocurable resin composition [A3] was continuously ejected in droplet form while moving the robot, to be applied to an area of 25 mm×70 mm, and this coating film was irradiated with ultraviolet light at about 200 mW/cm² for 5 seconds using the above UV-LED irradiator as in Example 2 (wavelength of 365 nm) to obtain a smooth coating cured film having a thickness of about 200 μm.

The same operation was repeated ten times to obtain a stereoscopic shaped object of 25 mm×70 mm×thickness of 2 mm. The time taken at this time was 10 minutes.

A specimen having a predetermined shape was cut out from the obtained stereoscopic shaped object, and the tensile properties were measured. As a result, the tensile strength was 7.97 MPa, and the elongation was 170%. The hardness was 60 (type A durometer).

Similarly, the photocurable resin composition [A3] was ejected in a circular shape to obtain a disk-shaped coating cured film, this process was repeated 62 times to laminate the cured films, to obtain a sample for compression set test with a diameter of 29 mm and a thickness of 12.5 mm. The time taken at this time was 18 minutes. A compression set test at 25% compression at 150° C. for 72 hours was carried out using this sample, and the compression set was found to be 22%.

### Example 4

The photocurable resin composition [A2] obtained in Formulation Example 2 and the photocurable resin composition [A3] obtained in Formulation Example 3 were used. As the apparatus, used as one obtained by equipping two jet dispensers (non-contact jet dispenser AeroJet manufactured by Musashi engineering) as non-contact dispensers and installing a UV-LED irradiator manufactured by CCS Inc. (HLDL-100U6, irradiation surface of 7 cm square, wavelength of 365 nm) as an ultraviolet irradiation device in the same coating robot as in Example 1, so that applying of the photocurable resin composition and irradiation with a ultraviolet light to the coating film can be continuously performed.

First, the photocurable resin composition [A3] was continuously ejected in droplet form from a nozzle port at a set temperature of 60° C. to be applied to an area of 25 mm×70 mm, and the coating film was cured by irradiation with ultraviolet light. Thereafter, the photocurable resin composition [A2] was similarly ejected from a nozzle port (set temperature of 60° C.) of another non-contact dispenser onto the cured coating film of the photocurable resin composition [A3] to form a coating film of the photocurable resin composition [A2], and the coating film was cured by irradiation with ultraviolet light. After repeating this operation five times, finally, the photocurable resin composition [A3] was applied and cured to obtain a stereoscopic shaped object of 25 mm×70 mm×thickness of 2 mm in which [A2]/[A3] was alternately laminated. The time taken at this time was 21 minutes.

The amount of one droplet of the photocurable resin composition [A2] ejected from the nozzle port (60° C.) was 60 nL to 80 nL, and the amount of one droplet of the photocurable resin composition [A3] was 80 nL to 100 nL.

A specimen having a predetermined shape was cut out from the obtained stereoscopic shaped object, and the tensile properties were measured. As a result, the tensile strength was 3.98 MPa, and the elongation was 180%. The hardness was 27 (type A durometer).

The dynamic viscoelasticity was measured using a specimen prepared from the stereoscopic shaped object obtained in Examples 2 to 4, and it was found that the glass transition temperature of the [A2] single laminate (Example 2) was −31° C., that of the [A3] single laminate (Example 3) was −17° C., and that of the [A2]/[A3] alternate laminate (Example 4) was −30° C. The tan δ value at 23° C. was 0.65 for the [A2] single laminate, 0.25 for the [A3] single laminate, and 0.73 for the [A2]/[A3] alternate laminate.

From these results, it was revealed that the [A2]/[A3] alternate laminate exhibits physical properties in the middle of each single cured product, but exhibits a unique characteristic that the rheological property in dynamic viscoelasticity has a value very close to that of [A2].

### Formulation Example 4

To 30 parts of the polymer [P1] obtained in Synthesis Example 1 and 70 parts of the polymer [P2] obtained in Synthesis Example 2 were added 1 part of IRGANOX 1010 (manufactured by BASF Japan) as an antioxidant, 20 parts of LA (manufactured by KYOEISHA CHEMICAL Co., LTD, lauryl acrylate) and 1 part of Viscoat#295 (manufactured by OSAKA ORGANIC CHEMICAL INDUSTRY LTD., trimethylolpropane triacrylate) as diluent monomers, 4 parts of IRGACURE TPO (manufactured by BASF Japan, 2,4,6-trimethylbenzoyl-diphenyl-phosphine oxide) as a photo-radical initiator, and 4 parts of triphenylphosphine as an adjuvant of the photo-radical initiator, and the mixture was sufficiently dissolved and mixed, then defoamed to obtain a photocurable resin composition [A4]. The viscosity of the obtained photocurable resin composition [A4] was 5.0 Pa·s (23° C.).

### Example 5

Using the photocurable resin composition [A4] obtained in Formulation Example 4, the photocurable resin composition [A4] was continuously ejected in droplet form from the nozzle port at a set temperature of 50° C. to be applied to an area of 25 mm×70 mm, using the same apparatus as in Example 2, to form a coating film. This coating film was irradiated with ultraviolet light (wavelength 365 nm) at about 200 mW/cm² for 5 seconds using the same UV-LED irradiator as in Example 2 to obtain a smooth coating cured film having a thickness of about 170 μm. The amount of one droplet ejected from the nozzle port (50° C.) was 60 nL to 80 nL.

The same process was repeated twelve times to obtain a stereoscopic shaped object of 25 mm×70 mm×thickness of 2 mm. The time taken at this time was 21 minutes and 20 seconds.

### Formulation Example 5

To 100 parts of the polymer [P3] obtained in Synthesis Example 3 was added 1 part of IRGANOX 1010 (manufactured by BASF Japan) as an antioxidant, 50 parts of ACMO (manufactured by KJ Chemicals Corporation, acryloyl morpholine), 10 parts of LIGHT ACRYLATE 130A (manufactured by KYOEISHA CHEMICAL Co., LTD, methoxy-polyethylenegrycol acrylate) and 1 part of Viscoat#295 (manufactured by OSAKA ORGANIC CHEMICAL INDUSTRY LTD., trimethylolpropane triacrylate) as diluent monomers, 4 parts of IRGACURE TPO (manufactured by BASF Japan, 2,4,6-trimethylbenzoyl-diphenyl-phosphine oxide) as a photo-radical initiator, and 4 parts of triphenylphosphine as an adjuvant of the photo-radical initiator, and the mixture was sufficiently dissolved and mixed, then defoamed to obtain a photocurable resin composition [A5]. The viscosity of the obtained photocurable resin composition [A5] was 7.9 Pa·s (23° C.).

### Example 6

Using the photocurable resin composition [A5] obtained in Formulation Example 5, the photocurable resin composition [A5] was continuously ejected in droplet form from the nozzle port at a set temperature of 50° C., using the same apparatus as in Example 2, to be applied to an area of 25 mm×70 mm to form a coating film. This coating film was irradiated with ultraviolet light (wavelength 365 nm) at about 200 mW/cm² for 5 seconds using the same ultraviolet light irradiator as in Example 2 to obtain a smooth coating cured film having a thickness of about 170 μm. The amount of one droplet ejected from the nozzle port (50° C.) was 90 nL to 110 nL.

The same process was repeated twelve times to obtain a stereoscopic shaped object of 25 mm×70 mm×thickness of 2 mm. The time taken at this time was 10 minutes and 20 seconds.

### Formulation Example 6

To 100 parts of commercially available urethane acrylate oligomer EBECRYL (registered trademark; the same applies hereinafter) 230 (aliphatic urethane acrylate, cured product Tg of −55° C., average molecular weight of 5000, average number of terminal acryloyl groups per molecule of the oligomer of 2) manufactured by DAICEL-ALLNEX LTD. were added 1 part of MARK AO-50 (manufactured by Adeka-Argus Co., Ltd., hindered phenolic antioxidant) as an antioxidant, 20 parts of LIGHT ACRYLATE 130A (manufactured by KYOEISHA CHEMICAL Co., LTD, methoxy-polyethylenegrycol acrylate) as a diluent monomer, and 2.5 parts of IRGACURE OXE-01 (manufactured by BASF Japan, 1,2-octanedione,1-[4-(phenylthio)-,2-(O-benzoyloxime)]) as a photo-radical initiator, and the mixture was sufficiently dissolved and mixed, then defoamed to obtain a photocurable resin composition [A6]. The viscosity of the obtained photocurable resin composition [A6] was 13 Pa·s (23° C.).

### Example 7

Using the photocurable resin composition [A6] obtained in Formulation Example 6, the photocurable resin composition [A6] was continuously ejected in droplet form from the nozzle port at a set temperature of 50° C., using the same apparatus as in Example 2, to be applied to an area of 25 mm×70 mm to form a coating film. This coating film was irradiated with ultraviolet light (wavelength 365 nm) at about 200 mW/cm² for 5 seconds using the same UV-LED irradiator as in Example 2 to obtain a smooth coating cured film having a thickness of about 290 μm. The amount of one droplet ejected from the nozzle port (50° C.) was 40 nL to 60 nL.

The same process was repeated seven times to obtain a stereoscopic shaped object of 25 mm×70 mm×thickness of 2 mm. The time taken at this time was 11 minutes.

### Formulation Example 7

To 100 parts of commercially available urethane acrylate oligomer EBECRYL 210 (aromatic urethane acrylate, cured product Tg of −19° C., average molecular weight of 1500, average number of terminal acryloyl groups per molecule of the oligomer of 2) manufactured by DAICEL-ALLNEX LTD. were added 1 part of MARK AO-50 (manufactured by Adeka-Argus Co., Ltd., hindered phenolic antioxidant) as an antioxidant, 30 parts of LIGHT

ACRYLATE 130A (manufactured by KYOEISHA CHEMICAL Co., LTD, methoxy-polyethylenegrycol acrylate) as a diluent monomer, and 2.5 parts of IRGACURE OXE-01 (manufactured by BASF Japan, 1,2-octanedione,1-[4-(phenylthio)-,2-(O-benzoyloxime)]) as a photo-radical initiator, and the mixture was sufficiently dissolved and mixed, then defoamed to obtain a photocurable resin composition [A7]. The viscosity of the obtained photocurable resin composition [A7] was 9 Pa·s (23° C.).

### Example 8

Using the photocurable resin composition [A7] obtained in Formulation Example 7, the photocurable resin composition [A7] was continuously ejected in droplet form from the nozzle port at a set temperature of 50° C., using the same apparatus as in Example 2, to be applied to an area of 25 mm×70 mm to form a coating film. This coating film was irradiated with ultraviolet light (wavelength 365 nm) at about 200 mW/cm² for 5 seconds using the same UV-LED irradiator as in Example 2 to obtain a smooth coating cured film having a thickness of about 250 μm. The amount of one droplet ejected from the nozzle port (50° C.) was 120 nL to 140 nL.

The same process was repeated eight times to obtain a stereoscopic shaped object of 25 mm×70 mm×thickness of 2 mm. The time taken at this time was 10 minutes.

### Formulation Example 8

To 100 parts of commercially available polyester acrylate oligomer EBECRYL 810 (polyester acrylate, cured product Tg of −31° C., average molecular weight of 1000, average number of terminal acryloyl groups per molecule of the oligomer of 4) manufactured by DAICEL-ALLNEX LTD. were added 1 part of MARK AO-50 (manufactured by Adeka-Argus Co., Ltd., hindered phenolic antioxidant) as an antioxidant, and 2.5 parts of IRGACURE OXE-01 (manufactured by BASF Japan, 1,2-octanedione,1-[4-(phenylthio)-,2-(O-benzoyloxime)]) as a photo-radical initiator, and the mixture was sufficiently dissolved and mixed, then defoamed to obtain a photocurable resin composition [A8]. The viscosity of the obtained photocurable resin composition [A8] was 0.5 Pa·s (23° C.).

### Example 9

Using the photocurable resin composition [A5] obtained in Formulation Example 5 and the photocurable resin composition [A8] obtained in Formulation Example 8, the same apparatus as in Example 4 was used as an apparatus.

First, the photocurable resin composition [A5] was continuously ejected in droplet form from the nozzle port (50° C.) to be applied to an area of 25 mm×25 mm to form a coating film. This coating film was irradiated with ultraviolet light (wavelength 365 nm) at about 200 mW/cm² for 5 seconds using the same UV-LED irradiator as in Example 4 to cure the coating film. After repeating this operation until the coating cured film of the photocurable resin composition [A5] had a thickness of 2 mm, one layer of the photocurable resin composition [A8] was applied from the nozzle port (room temperature) to the surface of the uppermost layer of the coating cured film of the photocurable resin composition [A5], and irradiated with ultraviolet light under the same conditions to cure the coating film to obtain a stereoscopic shaped object of 25 mm×25 mm×thickness of 2 mm. The time taken at this time was 8 minutes.

The amount of one droplet of the photocurable resin composition [A5] ejected from each nozzle port was 90 nL to 110 nL, and the amount of one droplet of the photocurable resin composition [A8] was 5 nL to 10 nL.

### Example 10

The photocurable resin composition [A3] obtained in Formulation Example 3 was used, and as the applying and curing device of the photocurable resin composition, a non-contact jet dispenser PICO Pulse system manufactured by Nordson Corporation as a non-contact dispenser and a desk robot JR3303N manufactured by JANOME SEWING MACHINE CO., LTD. as a coating robot were used.

One droplet of the photocurable resin composition [A3] was ejected from the nozzle port at the set temperature of 80° C., and a coating film having a diameter of about 0.60 mm and a thickness of about 80 m was formed. This coating film was UV-cured. The amount of one droplet ejected from the nozzle port (80° C.) was 10 nL to 30 nL.

Further, by ejecting the droplet photocurable resin composition [A3] continuously from the nozzle port, the photocurable resin composition [A3] could be linearly (line length of 70 mm, line width of 0.7 mm, thickness of 0.12 mm) applied in 0.7 seconds. From this result, it can be seen that a stereoscopic shaped object of 70 mm×25 mm×thickness of 2 mm can be obtained in about 10 minutes.

Although the disclosure has been described with respect to only a limited number of embodiments, those skilled in the art, having benefit of this disclosure, will appreciate that various other embodiments may be devised without departing from the scope of the present invention. Accordingly, the scope of the present invention should be limited only by the attached claims.

What is claimed is:

1. A process for producing a photocured three-dimensional stereoscopic shaped object, the process comprising ejecting and applying a droplet of a photocurable resin composition (A) having a viscosity of 20 mPa·s to 500 Pa·s at 23° C. using a non-contact dispenser, wherein the droplet has a volume of 1 nL or more.

2. The process according to claim 1, wherein the photocurable resin composition (A) comprises a photocurable resin (I) having a photocrosslinkable group represented by the following general formula:
—OC(O)C(R¹)═CH₂
wherein R¹ represents a hydrogen atom or an organic group having 1 to 20 carbon atoms.

3. The process according to claim 2, wherein the photocurable resin (I) has an average of at least 0.8 photocrosslinkable groups per molecule at a molecular chain end.

4. The process according to claim 2, wherein the photocurable resin (I) has a molecular weight of 1,000 or more.

5. The process according to claim 2, wherein the photocurable resin (I) is one or more selected from the group consisting of urethane (meth)acrylate resins, epoxy (meth)acrylate resins, polyester (meth)acrylate resins, silicone (meth)acrylate resins, and (meth)acrylic (meth)acrylate resins.

6. The process according to claim 2, wherein the photocurable resin (I) is a (meth)acrylic polymer synthesized by a living radical polymerization method.

7. The process according to claim 1, wherein the photocurable resin composition (A) further comprises 0.01 to 20 parts by weight of a photoinitiator (II), with respect to 100 parts by weight of the photocurable resin (I).

8. The process according to claim 1, wherein the photocurable resin composition (A) further comprises 0.1 to 200 parts by weight of a diluent monomer (III), with respect to 100 parts by weight of the photocurable resin (I).

9. The process according to claim 1, wherein two or more kinds of different photocurable resin compositions (A) are used.

10. The process according to claim 1, wherein the photocurable resin composition (A) is cured using light having a peak illuminance at a wavelength of 350 nm or more.

11. The process according to claim 1, wherein the non-contact dispenser is a jet dispenser or a pneumatic dispenser.

12. The process according to claim 1, wherein the volume of the droplet is 1 nL to 1000 nL.

13. The process according to claim 1, further comprising forming a three-dimensional shape by laminating cured products by repeating ejection and curing the photocurable resin composition (A) while changing a relative position of the non-contact dispenser and a stage by a driving unit of an apparatus,
wherein the apparatus comprises the non-contact dispenser, the stage, and the driving unit,
wherein the stage receives the photocurable resin composition (A) ejected from the non-contact dispenser, and
wherein the driving unit moves at least one of the non-contact dispenser and the stage.

14. The process according to claim 1, further comprising forming a three-dimensional shape by repeatedly applying the photocurable resin composition (A) five or more times using the non-contact dispenser.

15. The process according to claim 1, wherein at least a part of the photocured three-dimensional stereoscopic shaped object has a glass transition temperature (Tg) of 25° C. or less.

16. The process according to claim 1, further comprising:
forming a coating film of the photocurable resin composition (A);
curing the coating film; and
producing a shock absorbing material having a desired shape by repeating the forming and the curing.

17. The process according to claim 1, further comprising:
forming a coating film of the photocurable resin composition (A);
curing the coating film; and
producing a vibration-proof material having a desired shape by repeating the forming and the curing.

18. The process according to claim 1, further comprising:
forming a coating film of the photocurable resin composition (A);
curing the coating film; and
producing a damping material having a desired shape by repeating the forming and the curing.

19. The method according to claim 1, further comprising:
forming a coating film of the photocurable resin composition (A);
curing the coating film; and
producing a sealing material having a desired shape by repeating the forming and the curing.
